(19) United States
(12) Patent Application Publication
(10) Pub. No.: US 2017/0011311 A1
(43) Pub. Date: Jan. 12, 2017

(54) QUEUE AND RESERVATION MANAGEMENT SYSTEM

(71) Applicant: QLESS, INC., Pasadena, CA (US)

(72) Inventors: Alejandro BACKER, PASADENA, CA (US); Timothy Ross McCUNE, SANTA MONICA, CA (US)

(21) Appl. No.: 15/276,683

(22) Filed: Sep. 26, 2016

Related U.S. Application Data
(63) Continuation of application No. PCT/US2015/022530, filed on Mar. 25, 2015.
Application No. PCT/US2015/022530 is a continuation-in-part of application No. 14/451,372, filed on Aug. 4, 2014.
Application No. 14/451,372 is a continuation of application No. 13/157,254, filed on Jun. 9, 2011, now Pat. No. 8,831,963.
Application No. 13/157,254 is a continuation-in-part of application No. 11/941,849, filed on Nov. 16, 2007, now abandoned.
(60) Provisional application No. 61/970,573, filed on Mar. 26, 2014.
(60) Provisional application No. 61/970,693, filed on Mar. 26, 2014.
(60) Provisional application No. 61/970,583, filed on Mar. 26, 2014.
(60) Provisional application No. 61/353,638, filed on Jun. 10, 2010.
(60) Provisional application No. 60/893,644, filed on Mar. 8, 2007.

(51) Int. Cl. G06Q 10/02; H04L 29/08

(52) U.S. Cl. CPC G06Q 10/02; H04L 67/18

(57) ABSTRACT

A computer implemented method for controlling a queue for services including providing a user with a software application for use with a device that can send the device's location, receiving at the server the location of the user's device, maintaining a virtual queue with the server, and sending a request to the user's device for the user to join the queue when the user's device is within a predetermined space.

### CROSS-REFERENCE TO RELATED APPLICATION

The present application is a continuation of International Application PCT/US2015/022530 (Applicant Reference 50537-1PCT) filed on Mar. 25, 2015, which claims priority to U.S. Provisional Patent Application No. 61/970,573 filed on Mar. 26, 2014, U.S. Provisional Patent Application No. 61/970,583 filed on Mar. 26, 2014, and U.S. Provisional Patent Application No. 61/970,693 filed on Mar. 26, 2014, the contents of all of which are incorporated in this disclosure by reference in their entirety. The present application is also a continuation-in-part of U.S. patent application Ser. No. 14/451,372 filed on Aug. 4, 2014, which is a continuation of U.S. patent application Ser. No. 13/157,254 filed on Jun. 9, 2011 and issued as U.S. Pat. No. 8,831,963 on Sep. 9, 2014, which in turn is a continuation-in-part of U.S. patent application Ser. No. 11/941,849 filed on Nov. 16, 2007 and claims benefit of U.S. Provisional Patent Application No. 61/353,638 filed on Jun. 10, 2010, said U.S. patent application Ser. No. 11/941,849 claiming benefit of U.S. Provisional Patent Application No. 60/893,644 filed on Mar. 8, 2007, the contents of all of which are incorporated in this disclosure by reference in their entirety.

### BACKGROUND

There are known computer implemented methods for managing queues and reservations. Such a system that allows people to virtually queue “in line” via text messaging or mobile phone calls is described in U.S. Patent Publication No. 2008/0133283.

It is desirable to improve such known systems to better meet customer/user expectations, and to maximize the use of the resources of a service provider. For example, a queue or reservation management system that increases patronage of a restaurant, as compared to current systems, is desirable.

### SUMMARY

The present invention is directed to a system, including computer-implemented methods, which provide these improvements. Generally, in one version of the invention, advantage is taken of determining the location of the user based on information from a device of the user for transforming a virtual queue such as by adding a user to the queue. For example, one version of the invention is a computer-implemented method for controlling a queue for services. The method comprises providing the user with a software application for use with a device that can send the device's location, such a GPS enabled cell phone. The location of the user's device is received directly from the user's device. A virtual queue is maintained, and a request is sent to the user's device for the user to join the queue when the user's device is within a pre-determined space, such as within a store or an associated parking area. The method can include the additional steps of receiving requests from the user to join the virtual queue and the user is placed in the virtual queue, thereby modifying the virtual queue.

In another version of the invention, rather than sending a request to the user, the user can automatically be placed in the queue when the user's device is within the predetermined space and it can be communicated to the user that the user has been placed in the queue. The method also allows a user to request to be removed from the queue or change place in the queue and in response to that the virtual queue is changed in accordance with the user's request.

In another version of the invention, directed to controlling reservations for services, a request from a user for services is received and the location of the user is determined directly from the device of the user that provides location information. The amount of time it will take the user to arrive for the services from the determined location is determined and the user is placed in the queue with a reservation time. The reservation time is no earlier than the time it is determined the user will arrive, and the determined reservation time is communicated to the user. Optionally the method allows receipt from the user of a second reservation time later than the determined reservation time, and in that case the user is placed in the queue with the second reservation time.

In another version of the invention, a request is received from the user for services and the user is placed in a virtual queue for the services. Again the location of the user is determined directly from a device of the user that provides location information. The amount of time it will take for the user to arrive for the services from the determined location is determined. The place of the user in the virtual queue can be changed based on the determined amount of time. The change of place in the virtual queue can then be communicated to the user. Changing one user in place in the queue can affect other users, and optionally that change in place can be communicated to other users. As an example, changing the place of the first user can comprise not offering services to the first user when the first user is first in the queue.

In another version of the invention, in addition to determining the amount of time it will take the user to arrive for the services, also determined is a second amount of time it will take the user to be near the front of the queue. If the amount of time it will take the user to arrive for the services is greater than the amount of time it will take the user to be near the front of the queue, the user can be sent an inquiry asking if the user wants to remain in the queue. If the user responds that the user wants to remain in the queue then the position of the user can be changed in the virtual queue.

In another version of the invention, once the location of the user is determined, the user can be summoned for the services, but only when the user is within a pre-determined distance from the service provider.

Typically a virtual queue has multiple customer/users in the queue. With this location determination method, summoning the user for service can be avoided when the user is too far from the service provider to arrive on time. Thus only users whose location are unknown or are within a pre-determined distance from the service provider are summoned.

In these various methods, it is advisable to flag summoned users in the virtual queue as having been summoned, and likewise flagging users who have received services as having been served.

An advantage of using a user's device to determine the user's location, is the method can include advising the user when to leave the user's determined location to obtain the services so that the user does not needlessly leave too early, or leave too late to obtain their place for services.

In a reservation method, from the location of the user, it is possible to determine how long it will take the user to arrive for the services. That amount of time can be compared to how long it takes the last user in the queue to arrive at the front of the queue. Based on the information, the user can be advised of the greater of the two amounts of time so that the user can make a reservation time no sooner than the greater of the times.

The location-based method is also useful for where there are multiple service providers providing the same or similar services, such as multiple Italian restaurants, each having a virtual queue. Such a method comprises receiving a request from a new user for services, automatically determining the location of the new user directly from the device of the user that provides location information, and determining the amount of time it will take the user to arrive for the services from the determined location to multiple service locations, and in particular, at least first and second service location. The user can be advised of the shorter of the first and second amounts of time, or both the first and the second amounts of time. The information provided the user could rank the times from the shortest to the longest. The user can choose the location to make a reservation based on the information provided and the virtual queue for that location can be changed or transformed based on the that choice.

In another version of the invention, multiple virtual queues are maintained for multiple locations providing a service. In response to a request for services from a user, the user can be advised of the queue length of the multiple locations.

Another version of the invention is directed to a wandering user, where the user is at one time within a predetermined distance from the service provider, but is subsequently determined to no longer be within the predetermined distance. This user can be contacted to determine if the user still wants to receive the services. This is useful for when a user changes his/her mind about receiving the services.

Similarly, if it is determined a user is not within a predetermined distance from the service provider, the user can be queried to determine if the user still wants to receive the services, wants to leave the present location of the user to obtain the services, or change position in the queue. This is useful where the user's location is such that the user cannot arrive in time to receive the services based on the user's position in queue.

Another version of the invention is directed to “swapping.” For example if there are multiple users in the virtual queue including a buyer user and a seller user, the users can swap places in the queue. However consideration is provided to the seller for swapping places in the queue only if the seller arrives for the services. This avoids people just reserving space in a queue to sell it without an intent to use the services. Typically the buyer user is farther back in the queue than is the seller user. The system can also allow auctioning off of a seller's place in the queue. The system can also profit the host that maintains the virtual queue when a buyer user is willing to pay more than a seller user, wherein the host receives the difference. When there are multiple potential seller users and multiple potential buyer users, the buyer users can be matched to sellers to maximize the difference between what buyer users will pay as consideration to seller users where the difference is received by a host.

The invention also includes methods for controlling highway traffic comprising the steps of receiving a request for highway access from a user, where the user has a vehicle remotely detectable, and providing the user with a time reservation for access. The method includes detecting on the highway users with a reservation and charging users with a reservation a first price for the highway access and users without a reservation a second price, the first and second prices being different. Typically the user with the reservation pays more so that the first price is higher than the second price, which can be zero. Highway access can be an on ramp or can be a designated highway lane. The step of providing the user with a time reservation for access can comprise directly identify the location of the user from the device of the user, determining the amount of time it will take the user to access the highway from the identified location, and provide the user with timer reservation no earlier than the determined amount of time, and typically later.

In another version of the invention, the virtual queue system can be controlled by queue length. This can involve setting a maximum number of users who have been alerted to receive the services but not yet have received the services, and a minimum of number of users who have been alerted to receive this service but have not yet received the services. Users are alerted to arrive only when the number of users who have been alerted, but have not yet received the services, is not greater than the maximum number and not less than the minimum number.

In another version of the invention, rather than setting the minimum and maximum number of users, the wait time is used to control the queue. The method comprises setting a maximum amount of time the last user who has been alerted but not yet received the services needs to wait for the services, and setting a minimum amount of time the last user who has been alerted but not yet received the services needs to wait for the services. In this method users are alerted to arrive only when the last user has been alerted, but has not yet received the services, and only when the amount of time since the last user, who has been alerted but not yet received the services, was alerted is not greater than the maximum amount and not less than the minimum amount.

The hardware for practicing these methods can comprise a server having a processor, memory such as RAM or a hard disk, an input port for receiving data, and an output port for exporting data. The server can be provided by an application service provider or can be a server of the entity providing service to the users.

### BRIEF DESCRIPTION OF DRAWINGS

These and other features, aspects, and advantages of the present invention will become better understood with regard to the following description, appended claims, and accompanying drawings where:

FIG. 1 depicts an overview of a queuing system.

FIG. 2 depicts an exemplary operation of the queuing system.

FIG. 3 depicts communications between a queue-managing system and cell phones.

FIG. 4 depicts a general operation of an interactive voice response (IVR) system.

FIG. 5 depicts communications between the queue-managing system and an individual computer.

FIG. 6 depicts communications between the queue-managing system and a kiosk electronic device.

FIG. 7 depicts communications between the queue-managing system and entity-end devices.

FIG. 8 depicts an exemplary method of searching in the internet for potential users of the queuing system.

FIGS. 9-10 depict exemplary models for advertising using the queuing system.

FIG. 11 is a flow diagram illustrating one scenario in the use of a method for managing a queue for providing services in accordance with the present invention.

FIG. 12 is a flow diagram illustrating another scenario in the use of a method for managing a queue for providing services in accordance with the present invention.

FIG. 13 is a flow diagram illustrating another scenario in the use of a method for managing a queue for providing services in accordance with the present invention.

FIG. 14 is a flow diagram illustrating another scenario in the use of a method for managing a queue for providing services in accordance with the present invention.

FIG. 15 is a flow diagram illustrating another scenario in the use of a method for managing a queue for providing services in accordance with the present invention.

FIG. 16 is a flow diagram illustrating another scenario in the use of a method for managing a queue for providing services in accordance with the present invention.

FIG. 17 is a flow diagram illustrating another scenario in the use of a method for managing a queue for providing services in accordance with the present invention.

FIG. 18 is a flow diagram illustrating another scenario in the use of a method for managing a queue for providing services in accordance with the present invention.

FIG. 19 is a flow diagram illustrating another scenario in the use of a method for providing service appointments in accordance with the present invention.

FIG. 20 is a flow diagram illustrating another scenario in the use of a method for managing a queue for providing services in accordance with the present invention.

FIG. 21 is a flow diagram illustrating another scenario in the use of a method for managing a queue for providing services in accordance with the present invention.

FIG. 22 is a flow diagram illustrating another scenario in the use of a method for managing a queue for providing services in accordance with the present invention.

FIG. 23 is a flow diagram illustrating a scenario in the use of a method for swapping places in a queue in accordance with the present invention.

FIG. 24 is a flow diagram illustrating another scenario in the use of a method for swapping places in a queue in accordance with the present invention.

FIG. 25 is a flow diagram illustrating another scenario in the use of a method for swapping places in a queue in accordance with the present invention.

FIG. 26 is a flow diagram illustrating another scenario in the use of a method for swapping places in a queue in accordance with the present invention.

FIG. 27 is a flow diagram illustrating a scenario in the use of a method for providing access to a highway in accordance with the present invention.

FIG. 28 is a flow diagram illustrating another scenario in the use of a method for proceeding to a desired destination in accordance with the present invention.

FIG. 29 is a flow diagram illustrating another scenario in the use of a method for obtaining service at a desired destination in accordance with the present invention.

FIG. 30 is a flow diagram illustrating another scenario in the use of method for providing access to a highway in accordance with the present invention.

FIG. 31 is a flow diagram illustrating another scenario in the use of a method for providing access to a highway in accordance with the present invention.

FIG. 32 is a flow diagram illustrating another scenario in the use of a method for providing access to a highway in accordance with the present invention.

FIG. 33 is a flow diagram illustrating another scenario in the use of a method for providing access to a highway in accordance with the present invention.

FIG. 34 is a flow diagram illustrating another scenario in the use of a method for providing access to a highway in accordance with the present invention.

FIG. 35 is a flow diagram illustrating another scenario in the use of a method for managing a queue for providing services in accordance with the present invention.

### DETAILED DESCRIPTION

In the Summary above, in this Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally. The invention employs the queue system described below.

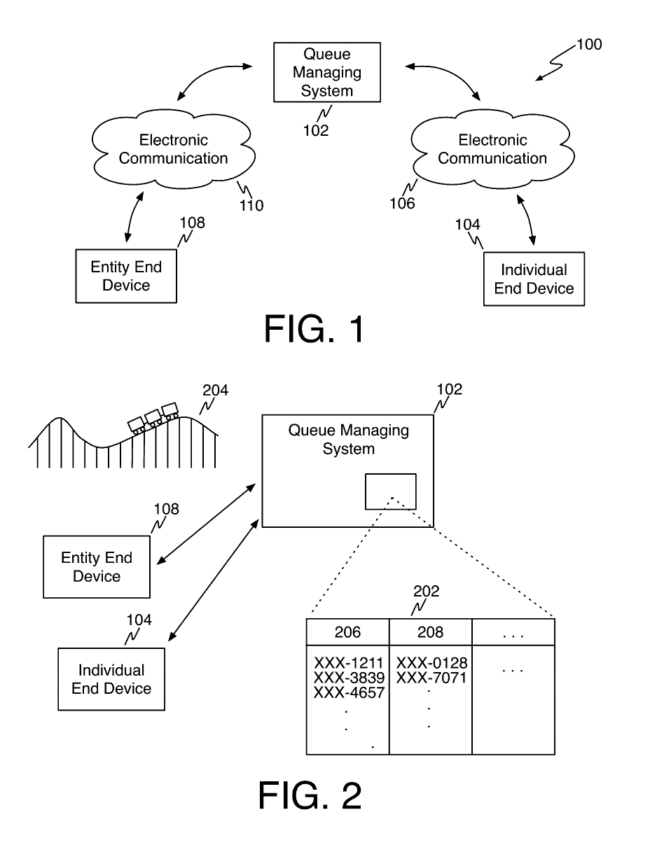

FIG. 1 shows an overview of an embodiment of the queue system (100). The queue system (100) comprises a queue-managing system (102), a plurality of individual-end devices (104) that communicate with the queue-managing system (102) via electronic communication (104), and a plurality of entity-end devices (108) that also communicate with the queue-managing system via electronic communication (110). As will be appreciated by persons of ordinary skill in the art, individual-end devices (104) may include cellular phones, personal data assistants, tablets, etc. Operation and control of such devices are well known in the art.

FIG. 2 shows an example of the operation step by step. First, an entity creates a virtual queue (204) on the queue-managing system through an entity-end device (108) or through a server. The virtual queue (202) corresponds to the actual queue for a facility, an attraction or service (204) the entity manages or provides. Examples include queues at a DMV, at government offices, queues for a table at a restaurant, queues for service at a restaurant, telephone queues for people waiting to talk on the phone with someone, virtual queues for an online meeting, queues to pick up a car at valet parking, queues for hotel check-in, queues for casino games, queues for admission to shows and/or night clubs, theme park attractions, theme park admission, healthcare providers, emergency rooms, dentists, tax offices, salons, Santa Claus pictures at the mall, retail shops, colleges (e.g., admissions, financial aid, advisement, registration, etc.), questions at Q&A sessions, queues to meet a person, queues at a fair, queues at freeway entrances, queues at the entrance to restricted freeway lanes, and many others. After creating the virtual queue (202), the queue-managing system (102) can periodically send to the entity-end device (108) the information regarding the status of the virtual queue (202). The entity can send with the entity-end device (108) information related to the availability of the resource being queued for to the queue-managing system (102), and the queue-managing system (102) will update the virtual queue (202) accordingly.

A person or entity (e.g. a device or a machine) who wants to enter the virtual queue (202) sends with an individual-end device (104) a status request to inquire the length of the estimated wait time, or the number of people or parties in the virtual queue. Such person or entity can also request to join the virtual queue (202). The request contains a unique individual identification number (or string value) of the person (columns 206 and 208) or other individual-specific information. Third, the queue management system (102) updates the virtual queue (202) according to the request and a set of rules. The update operation includes, among others, assigning a position in the virtual queue (202) to the individual identification number (206). The queue-managing system (102) usually assigns positions in the virtual queue (202) on a first-come-first-serve basis, but can assign such positions based on any business rule (e.g. priority pass holders can get priority), and there can be multiple priority tiers with different priorities. Rules can also restrict the number of queues that any given tier can enter at a time, or throughout the course of a day, or which queues the people can enter.

Fourth, when the entity advances the actual queue or changes the actual queue, the entity sends with the entity-end device (108) the relevant information to the queue-managing system (102). Upon receiving the information, the queue-managing system (102) updates the virtual queue (202) accordingly. The queue-managing system (102) can also update the virtual queue (e.g., wait forecasts) due to passage of time in absence of any signal from the entity-end device (108).

Fifth, when the individual is near or at the front of the virtual queue (202), the queue managing system (102) sends notifications to the individual-end device (104), which, in time, alerts the individual to his queue status. The individual can specify with how much advance notice he would like to be notified, before he is near or at the front of the virtual queue (202). For example, the individual may be 10 minutes away so the individual may desire to be notified by the queue-managing system 10 minutes earlier than when he would normally be notified. The individual can also use a global positioning system (GPS) or a position-sensing device to be notified with the advance notice necessary to make it in time.

The individual may send with the individual-end device (104) a request to leave the virtual queue (202). The queue-managing system (102) will update the virtual queue (202) according to the request. From the moment the individual sends a request to enter the virtual queue (202) until a certain period after he leaves the virtual queue (202), the queue-managing system (102) periodically communicates with the individual-end device (104). According to the information received respectively, the queue-managing system (108) updates the virtual queue (202) and the individual-end device (104) notifies the individual. In addition, the queue managing system (102) automatically updates the virtual queue (202) and other existing virtual queues according to a second set of rules.

An entity may subscribe to this system based on a “pay-as-you-go plan,” under which the entity only pays for its usage of the system. To use this system, an entity does not have to install or purchase any hardware. The system may provide short message service (SMS) marketing services which an entity may choose to join, and an individual may choose to receive or reject such marketing SMS messages via an individual-end device. This system is adapted to work in all industries and work globally in multiple languages. An entity may sign up for the system's service through a web-based interface.

### A. The Individual-End Device and Communication Between the Individual-End Device and the Queue-Managing System

### A1. Implementation of the Communication Between the Individual-End Device and the Queue-Managing System

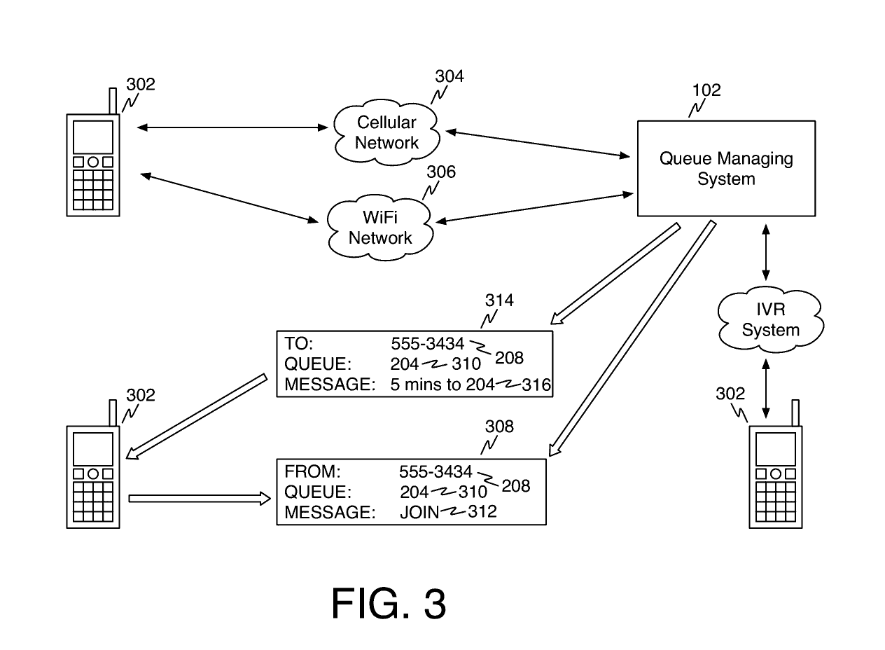

An embodiment of the individual-end device (104) is a cell phone (302) shown in FIG. 3. The communication between the cell phone and the queue-managing system (102) goes through a cellular network (304), Wi-Fi network (306), or any other class of communication network.

An embodiment of the communication between the cell phone (302) and the queue managing system (102) is text messaging (short message service, SMS or multimedia messaging service, MMS) or a related data communication protocol (308). A person can use a cell phone (302) to send a text message (308) to the queue-managing system (102). The message can contain a unique individual identification number of the person (208), which can be a phone number of the person and can be transmitted automatically in the caller ID header of the message, an identification string (e.g., a keyword or phrase) for the virtual queue (310), and a request code (312) (which can optionally be blank). The request code (312) indicates an individual's requests for updated status of the virtual queue, entering or leaving the virtual queue, etc. The queue-managing system (102) sends text messages (314) to the cell phone automatically or in response to the individual's request. The text message (314) from the queue managing system (102) may optionally contain a unique individual identification number of the person (208), an identification number of the virtual queue (310), and a short text (316) that answers the person's request, describes the updated status of the virtual queue, alerts the person to his position in the virtual queue, etc. Subsequent requests can optionally lack the identification string for the virtual queue (310) since the system already knows which queue the person is in, if the person is already in only one virtual queue.

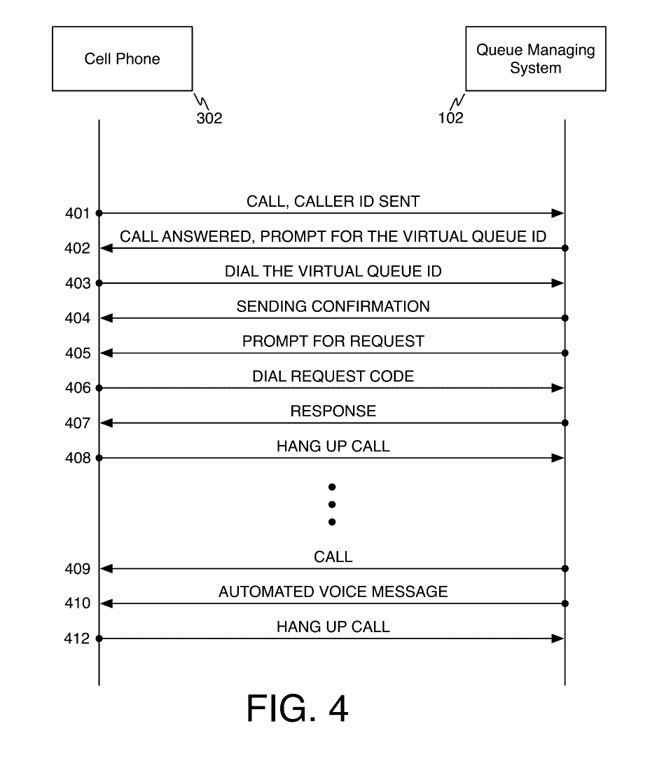

Another embodiment of the communication between the cell phone (302) and the queue managing system is an interactive voice response (IVR) system (318). FIG. 4 shows a general operation of the IVR system. The cell phone (302) calls (401) the queue-managing system (102). The cell phone (302) is identified to the queue-managing system (102) by the Caller ID information contained in the call (401). The queue-managing system (102) sends a pre [symbol] recorded or automatically generated voice message (402) to prompt for input of the identification number of the virtual queue, if multiple queues are available within that menu. The virtual queue identification number is then keyed in (403) by the cell phone (302), if multiple queues are available within that menu. The queue-managing system (102) may then confirm (404) that the virtual queue identification number has been keyed in (403). The queue managing system then sends a second set of pre-recorded automatically generated voice messages (405) to announce the wait time for that queue and prompt for the individual's request of entering the virtual queue (or leaving, changing positions, or changing notification method, if the person is already in a queue), thus reporting the status of the virtual queue.

The request is then keyed in (406) on the cell phone (302), and the queue-managing system (102) processes the request, updates the virtual queue, and responds accordingly (407). The cell phone (302) can now disconnect the call (408). Periodically, the queue-managing system (102) can optionally call (409) the cell phone (302) using the Caller ID number previously received (401) or an alternate number entered by the caller. The queue-managing system (102) sends an automated voice message (410) notifying the cell phone (302) user the information regarding the status of the virtual queue. The person can then disconnect the call (411).

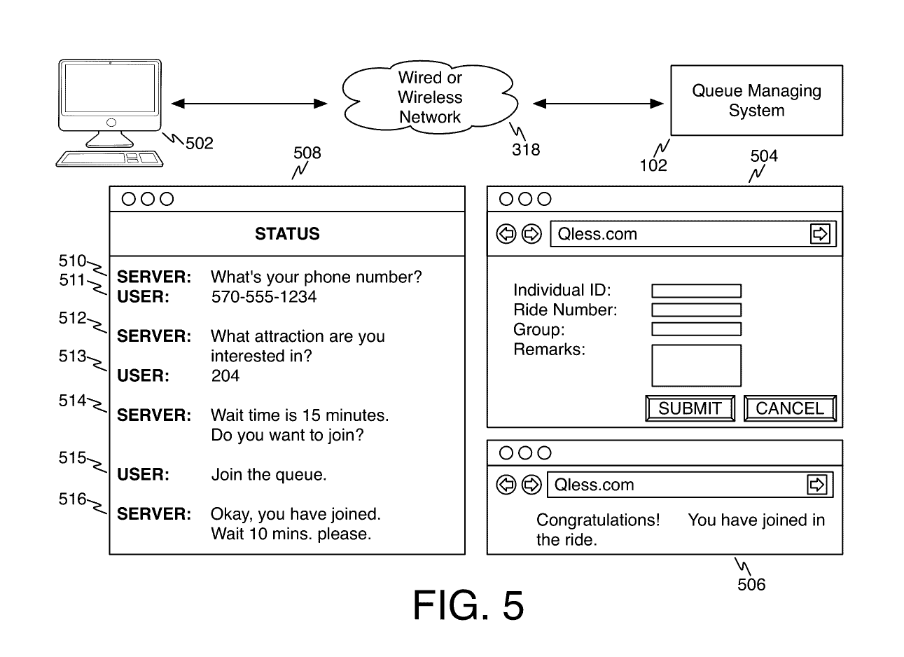

Another embodiment of the individual-end device is shown in FIG. 5 and communicates with the queue managing system (102) through an electronic button connected to the Internet or another communications network (318). Each button can be associated to a location (e.g., a user's table or desk) or a user, and the button can alert the queue management system with when and who needs service. Such buttons can also convey the type of service needed through multiple buttons or controls.

Another embodiment of the individual-end device (104) is a computer (502) or some similar electronic device having an Internet connection, and a web browser or an application or an instant messaging client. Communications between the individual computer (502) and the queue-managing system (102) can go through wired or wireless Internet connection.

An embodiment of the communication between the individual computer (502) and the queue managing system (102) can be a web-based interface (504). The individual uses a web browser and opens up the webpage (504) provided by the queue-managing system (102). The individual inputs an individual identification number, the virtual queue identification number, a request and other relevant information. The individual then submits such information through the web browser to the queue-managing system (102). The queue-managing system (102) processes the information, updates the virtual queue, and responds accordingly through an updated webpage (407).

Another embodiment of the communication between the individual computer (502) and the queue-managing system (102) also shown in FIG. 5 is instant messaging (508). The individual opens an instant message client and initiates a chat with the queue-managing system (102). The queue-managing system (102) may send a message to the individual for his identification number (510), or use his instant message identification (IM ID). The individual may then respond with his identification number (e.g., his phone number) (511), or simply use his IM ID. The queue-managing system (102) asks for the virtual queue identification string (512). The individual responds (or initiates the interaction) with the virtual queue identification string (513). Optionally, the queue managing system (102) asks what the individual wants to do (514). In one embodiment, the individual is assumed to want to join the queue when he sends the queue identification string. In another embodiment, the individual sends a code for his request (e.g., J for joining the virtual queue). In a third embodiment, the individual responds with his request, for example, the current wait time (515). The queue-managing system (102) processes the request, updates the virtual queue, and responds accordingly (516). At this point, the individual can stop the chat or send another request to the queue-managing system (102).

Another embodiment of the communication between the individual computer (502) and the queue-managing system (102) is by way of a computer application (app) running on a standard computer, a tablet, a phone or any device.

Another embodiment of the communication between the individual computer (502) and the queue-managing system (102) is by way of speech recognition by a computer of speech by the user.

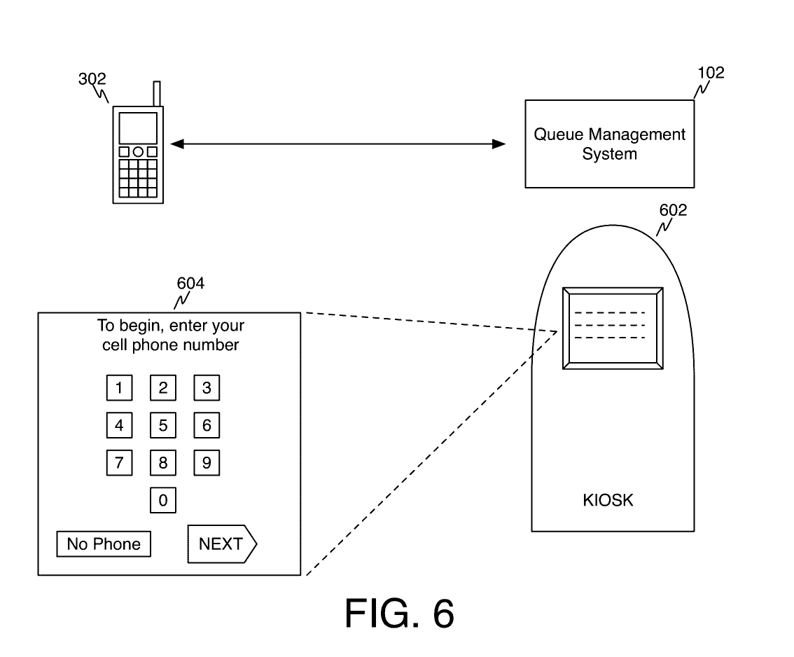

Another embodiment of the individual-end device (104) is a kiosk electronic device (602), shown in FIG. 6, that communicates with the queue-managing system (102) through wired or wireless Internet connection or a dedicated data connection. An example of the kiosk device is use a touch-panel and a display. The individual can enter his individual identification number, select the virtual queue he/she wants to join and complete his request. He can also enter any other relevant information by following the prompts on the screen and touching the screen (604). The kiosk sends all the information to the queue-managing system (102). The queue-managing system (102) processes the request, updates the virtual queue, and sends notifications or information to the kiosk (602) or another individual-end device, for example, a cell phone (302).

A2. Requests from the Individual to the Queue-Managing System

An individual can send many types of requests to the queue-managing system (102) via an individual-end device (104). An individual who wants to join a virtual queue can send a request to join a particular virtual queue via the individual-end device (104). An individual can select the form of communication the queue-managing system uses to notify him, including SMS messages and phone calls via the individual-end device (104). An individual who wants to join multiple virtual queues can send a request to join multiple virtual queues via the individual-end device (104).

An individual who wants to join a virtual queue can send additional information along with a request to join a virtual queue to accommodate specific needs (e.g., wheelchairs, high chairs, language requirements, preference for particular service agents, etc.) via the individual end device (104). In some embodiments where the individual has specific needs, the queue managing system can be further configured such that the individual with the specific need is summoned only when the entity's staff having the specifically needed skill is available. By way of example, and not of limitation, if the individual can only speak Spanish, then that individual is summoned only when an entity's Spanish speaking staff member is available; or if the individual is handicapped, then that individual is only summoned when a wheelchair-accessible service window is available. An individual who wants to join a virtual queue can purchase a right of priority that places the individual in a particular position or some other position in a particular virtual queue or multiple virtual queues via the individual-end device (104). An individual who wants to join a virtual queue can send requests for updated information regarding a particular virtual queue, such as current position in the queue, current wait time, etc., via the individual-end device (104). An individual who wants to join a virtual queue may reserve a particular position in a particular virtual queue at a specific time, via the individual-end device (104). An individual who has obtained a position in a virtual queue can send a request to swap positions with another individual who has also obtained a position in the virtual queue via the individual end device (104). Such swap can involve one individual paying the other individual to swap positions. An individual who has obtained a position in a virtual queue can send requests for updated information regarding a particular virtual queue, such as average wait time, current position in the queue, current wait time, etc., via the individual-end device (104). An individual who has obtained a position in a virtual queue can send a request to stay at a particular position in the virtual queue for a prolonged time via the individual-end device (104). An individual who has obtained a position in a virtual queue can send a request to abandon his position in the virtual queue and therefore leave the queue via the individual-end device (104).

An individual who has left a particular virtual queue or whose time expired after reaching the front of the queue can send a request to rejoin the virtual queue, within a certain period of time after expiration, in a position near where the individual left the queue via the individual-end device (104). An individual can be provided a custom vanity toll-free phone number to send requests to the queue-managing system (102). An individual can request for a first available position in multiple virtual queues within a single entity or across multiple entities. Under a first [symbol] available-queue mode, the individual will be assigned to multiple virtual queues within an entity or multiple queues across entities. When the individual reaches the front of one of the multiple queues, the queue-managing system (102) will automatically summon the individual to that particular queue and remove the individual from the other queues. Under the first-available queue mode as well as under other modes, an individual may send requests for more time via the individual-end device (104), and the queue-managing system (102) will automatically add more time to each position the individual has obtained in multiple queues.

A3. Notifications from the Queue-Managing System to the Individual

The queue-managing system (102) can send several types of notifications to the individual-end device (104) to respond an individual's request or to inform the individual an updated status of the virtual queue. The queue-managing system (102) can send an updated status of a particular virtual queue to the individual-end device (104), automatically, periodically, or in response to an individual or an entity's request. The queue-managing system (102) can automatically send updated status of a particular virtual queue to the individual-end device (104) when certain types of changes occur in the virtual queue, such as a significant decrease or increase in wait time. If the notification requires a reply by the individual, the queue-managing system (102) can periodically resend a notification to the individual-end device (104) until the individual responds. The queue-managing system (102) can periodically resend a notification to multiple individual end devices (104) in different forms of communication (e.g., text messaging, phone call, instant messaging, web pages, etc.) until the individual responds.

The queue-managing system (102) may send updated status of a particular virtual queue to the individual-end device (104) when the entity managing the actual queue enters new information or modifies the actual queue. The queue-managing system (102) may send summons notifications along with additional information, including assigned table, room number, store location, counter, etc., to the individual-end device. The queue-managing system (102) can send different types or levels of notifications to the individual-end device (104) according to the individual's position in the virtual queue (e.g., far from the front, near the front, at the front of the virtual queue).

When an individual is moved from one virtual queue to another virtual queue, the queue managing system (102) can send a notification to the individual-end device (104) to inform the individual of this change and the reason why he is moved to another queue. When a party of individuals as a whole enters a particular virtual queue, the party can specify multiple individual end devices, and the queue-managing system (102) can receive requests from and send notifications or responses to each of the specified individual-end devices. The queue-managing system (102) can send a confirmation notification to the individual end device (104) in response to the individual's request of reservation. When an individual decides to leave or not to enter a particular queue because the estimated wait time is too long, the queue managing system (102) can send a notification and an updated status of the virtual queue to the individual-end device (104) within a certain period, for example, if the wait time forecast decreases significantly.

### B. The Entity-End Device and Communication Between the Entity-End Device and the Queue Managing System

### B1. Implementation of the Communication Between the Individual-End Device and the Queue-Managing System

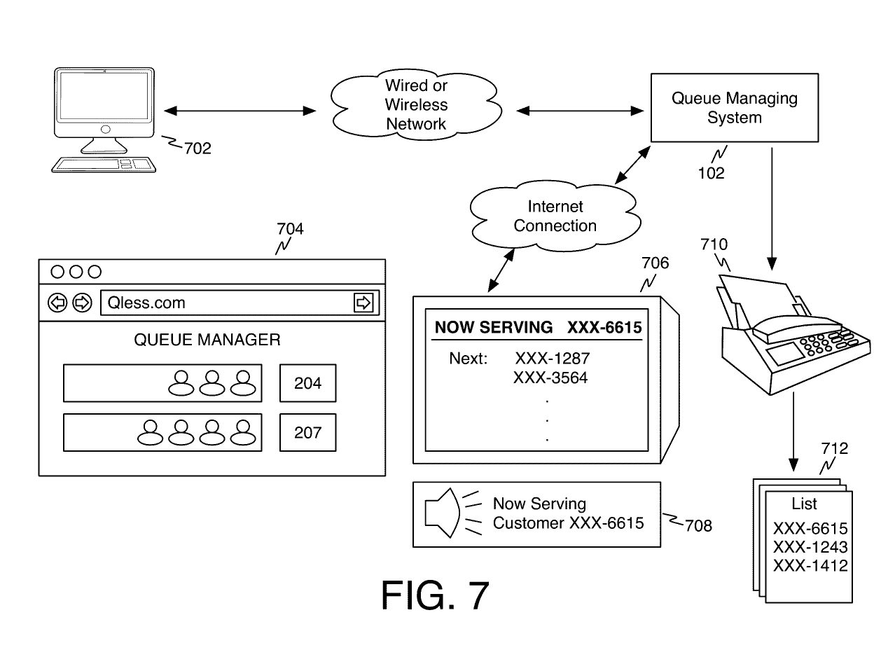

An embodiment of the entity-end device (108) is a computer (702), shown in FIG. 7, or some similar electronic device that has an Internet or cellular connection. Communications between the entity computer (702) and the queue-managing system (102) can go through the Internet connection, wired or wireless.

A further embodiment of the entity-end device is a computer or some similar electronic device that has an Internet connection and a non-physical-keyboard input interface, such as a Touch panel.

A further embodiment of the entity-end device is a computer or some similar electronic device that has Internet connection and sensors monitoring the status of the actual queue. An example of the sensor is a door sensor. When an individual passes through a door and is served, the sensor sends notification back to the queue-managing system (102) and the queue-managing system (102) updates and processes the virtual queue accordingly.

An embodiment of the communication between the entity computer (702) and the queue managing system (102) is a web-based interface (704). The entity uses a generic web browser and opens up a webpage (704) provided by the queue-managing system (102). The entity can input the information about the status of the actual queue thorough the webpage (704). The queue-managing system (102) processes the information, updates the virtual queue, and responds accordingly through an updated webpage.

Another embodiment of the communication between the entity computer (702) and the queue-managing system (102) is a third-party application that uses a set of web application programming interfaces (API) to communicate with the queue-managing system. An example of the third-party application is a common cash register program.

Another embodiment of the entity-end device (108) is a customer-facing monitor (706), shown in FIG. 7, or some similar electronic device that has an Internet connection. Communications between the customer-facing monitor (706) and the queue-managing system (102) goes through the Internet connection, wired or wireless. The customer-facing monitor automatically and periodically receives data from the queue-managing system (102) and notifies individuals both visually and audibly. An example of such notifications is displaying the individual being served and the individuals that will be served next. Another example of such notification is playing audible messages (708) to summon the individual in the front of the virtual queue.

Another embodiment of the entity-end device (108) can be a fax machine (710), shown in FIG. 7, or some similar electronic device that is capable of faxing. Communications between the fax machine (710) and the queue-managing system (102) goes through a telephone line. The entity may obtain information about the status of the virtual queue via the fax machine (710), including a list (712) of individuals enlisted in the queue. The fax machine may serve as a backup communication in case of Internet connectivity problems.

Another embodiment of the entity-end device (108) integrates with the private branch exchange (PBX) system to intercept callers that simply want to join the virtual queues.

Another embodiment of the entity-end device (108) can be a phone, which can be configured to send text messages to have the queue management system, for example, summon the next individual-end device.

### B2. An Entity's Operation on a Virtual Queue

An entity may perform multiple types of operations on the virtual queue via an entity-end device (108). An entity may search individuals enlisted in the virtual queue based on a set of criteria via an entity-end device (108). An entity may add call-ahead individuals into the virtual queue via an entity-end device (108), who can be skipped once they get to the front of the queue, until they are marked as arrived. An entity may summon an individual out of the queue through the one-click interface on an entity-end device (108). Individuals can be summoned in any order desired by the entity, for example, a first come first serve order, or in any order so-determined by the entity (e.g., an entity can summon any individual out of order). An entity may manually enable or disable a virtual queue via an entity-end device (108). When a virtual queue is enabled, individuals may request to join the virtual queue via an individual-end device (104). When a virtual queue is disabled, no individual may join the virtual queue via an individual-end device (104).

An entity may input forecast wait or other information relevant to the virtual queue via an entity-end device (108) and the queue-managing system (102) will send notifications of such updates to individual-end devices (104). An entity may choose to automatically have the queue management system notify every individual-end user behind a particular user of a change in a forecast. The queue management can automatically compute how each subsequent end-user's wait forecast changes after a manual change is introduced for one individual-end user's forecast.

An entity may move an individual from one virtual queue to another via an entity-end device (108). An entity may obtain lists of individuals in multiple virtual queues via an entity-end device (108). An entity may obtain the immediate history of a particular individual in a virtual queue via an entity-end device (108). An entity may obtain analysis reports of individual behaviors in a single virtual queue, or across multiple virtual queues via an entity-end device (108). The analysis reports may be displayed on the entity-end device (108), exported to files in different formats (e.g. spreadsheets), or exported to a local database. An entity may view individuals' actions in real time through a graphical interface on an entity-end device (108).

### C. The Queue-Managing System and its Functions

An embodiment of the queue-managing system (102) is a computer that is capable of receiving and sending information through text messaging, instant messaging, web pages, fax, and/or an IVR system.

The queue-managing system (102) stores virtual queue data and updates them according to information or requests from entities or individuals. The queue-managing system (102) also sends information or notifications to entity-end (108) or individual-end (104) devices automatically or in response to requests from entity-end (108) or individual-end (104) devices. In addition, the queue-managing system (102) can build a database of individual phone numbers.

The queue-managing system (102) can protect customer privacy by sending only partial phone numbers to the entities. The queue-managing system (102) may keep names and/or notes about individuals across entries in multiple queues. The queue-managing system (102) may direct individuals to specific locations when summoned (window numbers, dining rooms, etc.). The queue-managing system (102) may give employees of the entity specific restricted access through role-based privileges to simplify their user interfaces.

The queue-managing system (102) can maintain a fixed-size summoned customer pipeline by automatically summoning one customer every time another customer is marked as arrived. The queue-managing system (102) can automatically roll individuals in a virtual queue from one day to the next. When an individual is being served at another actual queue, the queue managing system (102) will not summon him to another queue. The queue-managing system (102) may consider travel time between actual queues and adjust travel time based on an individual's past speed. The queue-managing system (102) may change available queue options dynamically based on individual party size and special needs.

The queue-managing system (102) can move individuals from one queue to another automatically at a scheduled time. The queue-managing system (102) can support classifiers in an auto-summon-by-list-size mode such that individuals can be automatically summoned based on a specific classifier. Classifiers are attributes of a party or individual. The queue-managing system (102) may recognize an individual's phone number through caller ID and automatically place the individual in the virtual queue, thus eliminating individuals from having to input their phone numbers. The queue-managing system (102) can have a local backup copy of the system database at the entity-end device (108) in case of Internet breakdowns.

The queue-managing system (102) can automatically advance the virtual queue and summon the next individual at the front of the virtual queue at a specified rate, or in response to an event, such as a summoned person leaving the queue, their time expiring after a predefined interval of time, a summoned person pushing themselves back, etc. The queue-managing system (102) can automatically, periodically, or in response to the individual's or an entity's request, calculate and send notifications of forecasted wait time to individual-end devices (104). When the actual real-time forecasted wait time becomes less than a specified value (which can vary by the entity and by the individual), the queue-managing system (102) sends notification to individual end devices (104). The queue-managing system (102) can automatically summon the next party if the first summoned party does not show up. The queue-managing system (102) can close or disable virtual queues automatically based on capacity or when closing time approaches.

The queue-managing system (102) may track individual party sizes. The queue managing system (102) also provides a dynamically adaptive schedule mode. In such mode, an individual can request for a position in a queue around a desired time. When the scheduled time approaches and the individual or the entity is not available, the queue-managing system will automatically expire or postpone the individual's position in the virtual queue and call upon the next available individual. The queue-managing system can automatically assign an individual to another virtual queue when requested by the individual to join a particular queue, or after the individual is summoned and served, according to a set of rules.

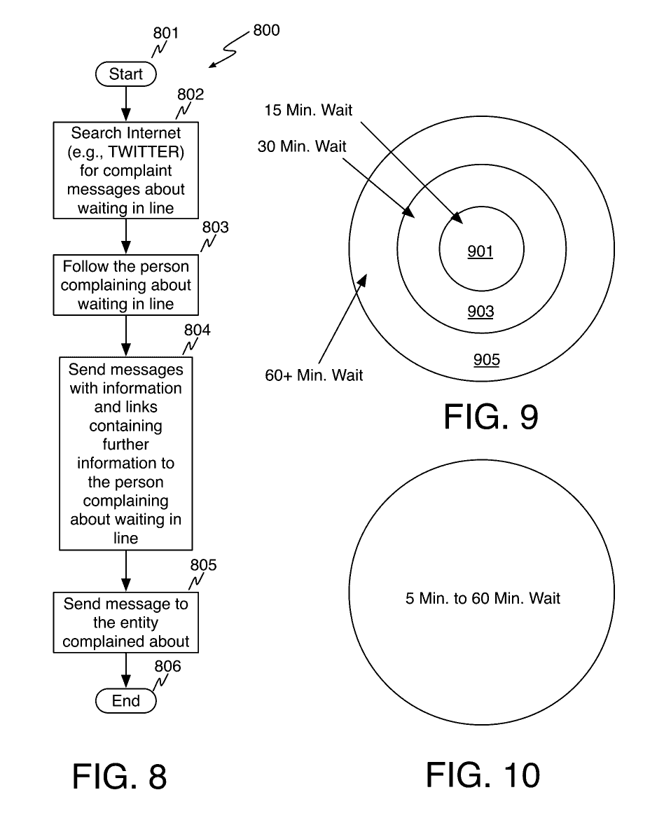

According to a method 800 in an embodiment of the present disclosure as shown in FIG. 8, the queue managing system (102) can automatically and periodically search the Internet for messages from Internet users who might be complaining about waiting in line. The method begins at reference numeral (80). At reference numeral (802) the system can automatically and periodically search the Internet for messages from Internet users who might be complaining about waiting in line, or writing about any particular topic, or mentioning any of a set of strings. When the queue-managing system (102) finds such messages, the system can automatically respond to their messages, for example by introducing the queue-managing system (102) of the present disclosure. By way of example and not of limitation, the queue-managing system (102) can periodically search TWITTER® pages for users posting messages with complaints regarding waiting in line. When the queue-managing system (102) finds a user who might be complaining about waiting in line, the queue-managing system (102) uses a TWITTER® account to “follow” (803) that user and further informs (804) that user of the queue-managing system (102) of the present disclosure. The TWITTER® account can contain information and links to direct an interested person to a website containing further information about the electronic queuing system of the present disclosure. At reference numeral (805) the system can also be configured to identify a corresponding email or social network account, (e.g. for the institution where the queue complaint was about), and notify them of their customer's complaint and a possible solution.

In yet a further embodiment, the queue-managing system (102) posts a message in response to the user's complaint. The response contains information regarding the electronic queuing system of the present disclosure. The queue-managing system (102) can search the Internet for specific messages and respond to them according to a set of rules. The set of rules can be defined to direct interested persons to websites related to the electronic queuing system of the present disclosure.

In another embodiment, the queue-managing system (102) lets individuals post a message on a social network to indicate that they are joining a queue, with a link allowing their friends or followers to join them. In one embodiment, the link allows their friends to join the queue at the same position as the poster, expanding the party size accordingly.

According to an embodiment of the present disclosure, the queue-managing system (102) can automatically and periodically send advertisement messages to an individual-end device (104) according to a set of rules for a person already in a queue. The set of rules can be defined such that the advertisement messages depend on the end device user's estimated wait time as shown in FIG. 9. For example, when a person has an estimated wait time less of than 15 minutes (901), the person may not be interested in activities of extended duration such as sitting down for a meal. In such case, the queue-managing system (102) can send advertisement messages, for example, regarding a quick coffee or refreshment. The advertisement messages can advertise for retail stores in the nearby vicinity that a customer can quickly attend and return within the estimated wait time. Ads can also take into account the previous history of the user and what establishments he/she has queued for, as well as the location corresponding to their phone number, the frequency of visits to each establishment, the time since their last visit, and more.

When a person has an estimated wait time of approximately 30 minutes (903), for example, the person may be able to sit down for services for a short while. The queue-managing system (102) may send advertisement message about fast-food restaurants, light rails, etc. The person may be able to drive, but the driving time/distance should be short (e.g., less than 5-minute drive).

When a person has an estimated wait time that can exceed, for example, more than one hour (905), the queue-managing system (102) can send the person advertisement messages concerning involved experiences, such as sit-down restaurants, car dealerships, etc. The person would have sufficient time to go further, thus the advertisement message may cover a targeted interest retailer.

According to an embodiment of the present disclosure as shown in FIG. 10, a less sophisticated model is presented in which the frequency at which the entity-end device (108) displays advertisement messages can depend on the length of the queue. For example, on a busy day with a long queue, the entity-end device (104) can cycle through advertisement messages at a faster rate. On a less busy day with a short queue, the entity-end device (104) can cycle through advertisement messages at a slower rate.

Charges for to an advertiser for advertisement messages can also depend on the queue-length. For example, advertisement messages for a long queue can be more expensive than those for a short queue due to the amount of users that may be exposed to such advertisement messages.

### D. Exemplary Uses of the Queue System

The embodiments of the queue system can be used, for example, by hotel management in a hotel room availability notification system. Hotels typically have a fixed earliest check-in time for arriving guests. This is to ensure previous guests that were occupying the hotel rooms have checked-out and that the hotel staff has had time to clean and prepare those rooms for the next guests. However, such fixed earliest check-in times could be made dynamic and updated on a real-time basis so that arriving guests can possibly check-in earlier if their rooms are available, or not have to show up until later if their rooms will be delayed. The system can thus minimize the hotel staff manpower needed by reducing peak attendance.

By implementing an embodiment of the automated virtual queuing system, an exemplary process can comprise a sequence of events as follows. A guest anticipating to arrive at a hotel can send an SMS text message to the hotel's queue-managing system anticipating their arrival. The queue-managing system can reply back to the arriving guest asking them to respond via SMS text message with identifying information such as their name, confirmation number or a rewards membership number (unless this information was sent in the first text message or communication by the guest). The guest can then reply with such information and a hotel staff will see that an arriving guest will be checking in soon. The hotel staff or hotel management system will determine the type of room (e.g., king suite, non-smoking, presidential suite, standard room, etc.) the guest should be checked-in to. Meanwhile, the queue-managing system can reply back to the guest to ask them to provide their estimated time of arrival (ETA). It is optional for the guest to provide this information but ETA information will assist the queue managing system to place them in appropriate precedence in the virtual queue as they wait for their hotel rooms. If ETA information is not provided by the guest, the guest will be placed in the next available place in the virtual queue and their room may be prepared immediately. At this point, the queue-managing system can send another SMS text message to the guest with confirmation of the room type assigned, their estimated wait time or personalized check-in time, and optionally a phone number where the guest can call to make any last minute changes and/or corrections to the reservation.

Room availability status is updated by the hotel staff once the previous guests have checked-out and the room is cleaned. Once the room is marked as being available and ready for the next guest, the queue-managing system can send another SMS text message to the arriving guest to inform them that their room is ready. In cases where the wait time exceeds a specified amount of time, the queue-managing system can send wait-time updates via further SMS text messages. When the guest physically arrives at the hotel, the guest can pick up their room key at their convenience.

In yet another example of the queue system, an individual can bid for preferred positions in the virtual queue. When the individual joins a virtual queue by one of the methods described in the present disclosure, the individual is provided an opportunity to purchase a better (e.g., closer to front of the line) position in the virtual queue. The process starts with the purchaser offering to pay a certain amount of money for the better position. The queue-managing system relays this offer to an individual who is in the front of the line in the virtual queue if they are interested in selling their position for a specified price. If the individual at the front of the line is willing to sell their position for the offered price, the queue-managing system will ask the purchaser to confirm the bid. If the person at the front of the line declines, the next person in line is offered to sell their position.

Once the seller and the purchaser both agree, either the purchaser's cell phone bill can be charged for the offered price or the purchaser's credit account. The seller can either receive credit to their cell phone bill or receive credit to their credit account.

In a further embodiment, the bidding system can generate revenue to both the seller, the merchant using the queuing system, and the queuing system provider. By way of example and not of limitation, the seller does not receive the entire amount of the purchaser's bid. Instead, a portion of the purchasing price can be provided to the merchant and another portion can be provided to the queuing system provider. Finally, the seller receives the remaining portion of the purchaser's bid price. Such method of dividing the revenue can potentially allow the merchant to obtain the queuing system either at a reduced cost or for free since the queuing system provider can generate revenue through the bidding method.

In yet a further embodiment, implementing the bidding method can attract individuals to the virtual queue for the sole purpose of selling their positions in the virtual queue. In order to avoid misuse of the queuing system, the queue-managing system can be designed to ensure ‘no-shows’ are not allowed to participate in the bidding process. However, they might still be allowed to join their virtual queue for their own use. In another embodiment, repeated no-shows might be penalized in their position in the queue to discourage repeated no-shows.

In another embodiment, priority or expedited service may be provided to a class of users. By way of example, and not of limitation, those who pay a convenience fee for expedited service, or frequent customers based on a database or the number of times they have been served by the queue management system in that establishment in the past.

In another example of the queue system, a dynamic reservation can be used in conjunction with the queuing system. In a dynamic reservation system, individuals can make a reservation time for a particular event (e.g., entrance to a museum, restaurant, etc.) by communicating with the queue-managing system, for example by way of either a cell phone or printing a physical ticket either online from home or an on-site kiosk. The event can also accept individuals who ‘walk-in’ without reservation. In such situations, individuals with reservations and the walk-ins can be integrated with the individuals in the virtual queue so that a certain amount of each group can be admitted. The specific amount to be admitted can change depending on a number of reservations made that day. For example, on days when fewer reservations are made, more walk-ins can be admitted, and vice versa, thus maximizing total throughput of the number of guests.

In yet a further embodiment of the joint queue-managing system and dynamic reservation system, when a reservation time for an individual is delayed, the individual can be informed of the delay and the expected delay time prior to the individual's arrival, thus minimizing inconvenience. Conversely, if the individual who made the reservation is delayed and cannot arrive at the previously assigned time, then the individual can inform the queue-managing system to request additional time. The joint queue-managing system and the dynamic reservation system can coordinate the changes in real-time to keep the flow of traffic moving, thus maximizing throughput. By keeping track of the actual times and lengths of appointments, the dynamic reservation system can maximize throughput while minimizing wait times by notifying users when they are actually likely to be served rather than using fixed-length fixed-time appointments.

In yet a further example embodiment, the queue-managing system can be configured to dynamically and adaptively manage appointments for a specific time/date (e.g., Tuesday at 3 pm) for a given customer. By way of example and not of limitation, in a dynamically managed appointment, if the appointment time is delayed due to delays by the service provider, the queue managing system can be configured to automatically adjust the appointment times according to the order of booked appointment times. Specifically, if due to delays by the service provider, the 3 pm appointment is delayed to 3:30 pm, then instead of servicing the 3:30 pm appointment at 3:30 pm, the queue-managing system will adjust appointment times as necessary such that the service provider can service the first user in line (in other words, the user that had initially booked the 3 pm appointment) first, before attending to the 3:30 pm appointment. Therefore, the queue-managing system can be configured to manage a combination of a virtual queue and appointment times of variable lengths in a dynamic and adaptive manner.

In one embodiment of the dynamic reservation system, users provide their availability (for example via access to their online calendar, or as start and end times for availability), and the system gives them a service time in an available period. By promising a range of times rather than an exact time, the system is able to adjust based on real time delays and timing to minimize wait times when users show up.

In another embodiment, the queue-managing system can be used at social gathering events for two or more people to coordinate their meeting at the event. For example, a first person wants to meet with a second person at a particular event. However, the first person and/or the second person may not necessarily know their schedule at the event, and therefore are unable to schedule a specific meeting time and/or location. The queue-managing system of the present disclosure can be used to assist in arranging their meeting by using their cell phones. For example, when the first person is available to meet, the first person can send a text message to the queue-managing system to inform the virtual queue that he is now available. The second person can then be notified by the queue-managing system that the first person is available. Whenever the first person and the second person are both available, the queue-managing system can inform both persons that they can now meet. The system preserves the privacy of each user's mobile phone number while allowing real-time communication between the parties. Multiple users interested in meeting a person can join a virtual queue for that person and get summoned sequentially as the person in question is ready to meet them.

In a social gathering event, there can be hundreds or thousands of people, thus making it difficult for two people to find each other. According to another embodiment of the present disclosure, when the first person and the second person are ready to meet each other, the queue managing system can assist them in finding each other. In a first method, the meeting location can be pre-arranged such that when they are ready to meet, the first person and the second person goes to the pre-arranged location. In a second method, when the first person or the second person notifies the queue-managing system through their cell phones, they can enter a desired or a suggested meeting location. In a third method, by way of example and not of limitations, at least the first person can have a portable global positioning system (GPS) device (e.g., a cell phone embedded with a GPS), such that the queue-managing system is able to determine the location of the first person according to information obtained from the GPS of the first person and inform the second person the location of the first person. At the coordinated meeting time, the second person can find the first person according to the information provided on his cell phone from the queue-managing system. A smartphone or computer application can direct each person to one another with directions using location information about each user in real-time and mapping data.

According to another example, the queue-managing system can be utilized in a live or virtual Question and Answer (Q and A) session wherein a speaker is answering questions asked by a group of attendees. In an exemplary Q and A session, if attendees have a question that they would like to ask the speaker, the attendees can submit their question by sending a text message with their question from their cell phones to the queue-managing system. At the Q and A session, there can be, for example, a display (e.g., projector) that shows a list of questions that are in queue. As the attendees submit their questions, the questions can be shown in the display for the other attendees to see.

If the attendees desire certain questions to be answered more than the other questions, the attendees can vote for the questions they like by sending a text message to the queue-managing system with the designated code for a particular question. A set of rules can be applied to the queue-managing system such that, for example, the question that has the most votes are given higher priority to be addressed by the speaker. Such rules can be applied in real-time as the Q and A session is taking place.

In a further example, the queue-managing system can be implemented to be used with call centers. In some situations, call centers can receive more calls than that can be answered by the number of personnel that are available to answer such calls at the call center. Instead of the callers being placed on hold on the phone while the callers wait for their calls to be answered, the callers can be placed in a virtual queue. The callers can join the virtual queue by way of example, calling the call center, sending a text message, or online via the Internet. By joining the virtual queue, the caller is able to hang up the phone and still maintain position in the queue. While the caller virtually waits his turn in line, he can check his status (e.g., expected wait time and/or order in the virtual queue) by way of example, calling, sending a text message or online via the Internet. When the caller's time gets to the front of the queue, the caller receives a phone call which connects the caller with a live person at the call center. The system can require the person who placed the call to respond (e.g., pressing a button) before the call is connected to the attendant to avoid unnecessary waits. If the person who placed the call is not available to take the call at that time, the system can be configured to make a call-back, or the person can push him or herself back in the virtual queue any desired period of time, as outlined above.

In yet a further example, a customer loyalty program can be implemented in the queue managing system. For example, when a customer becomes a repeating customer of the virtual queuing system, the queue-managing system can be configured to send a message (e.g., an SMS text message) to the customer once they have used the virtual queuing system more than a preset amount of times. Such message can contain a cardless reward such as a mobile coupon. Moreover, as the customer gets closer to reaching their required number of uses of the virtual queuing system, the queue-management system can be configured to send reminder messages with the remaining number of times that the customer needs to use the virtual queuing system before they earn their next reward.

The examples set forth above of exemplary use of the queue system in the invention are provided to give those of ordinary skill in the art a complete disclosure and description of how to make and use the embodiments of the queue system of the disclosure, and are not intended to limit the scope of what the inventors regard as their disclosure. Modifications of the above described modes for carrying out the disclosure may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

### E. Adaptation of the Queue System in the Invention

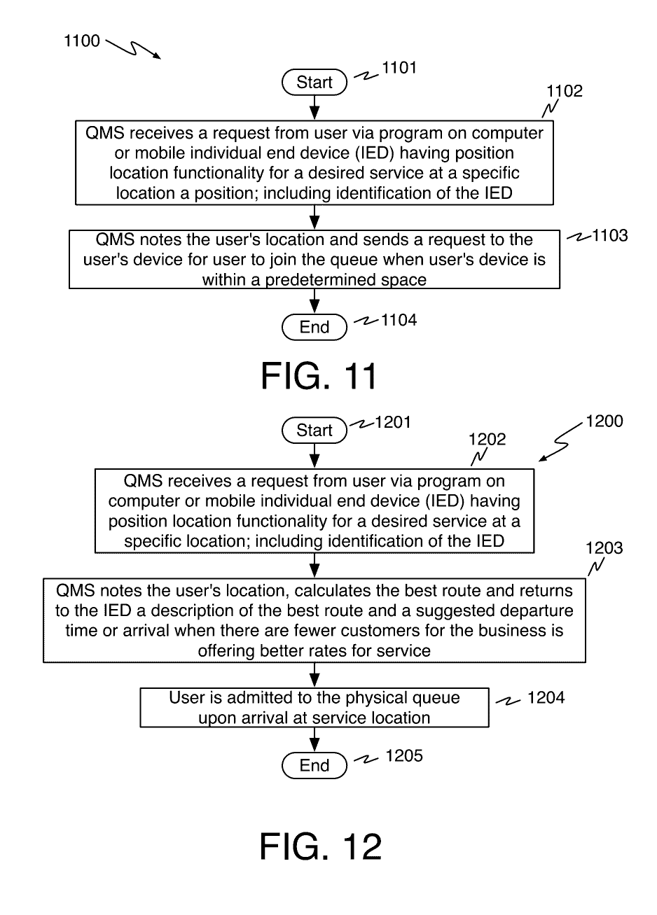

FIG. 11 illustrates one method (1100) for operating the queue system in the invention. The method starts at reference numeral (1101).

At reference numeral (1102), the QMS receives a request from a user via a program on a computer or mobile individual end device (IED) having position location functionality for a desired service at a specific location a position. The message identifies the IED. The message can be sent in a wide variety of ways including by text, phone call, mobile app, website, etc.

At reference numeral (1103), the QMS notes the user's location and sends a request to the user's device for user to join the queue when user's device is within a predetermined space. The method ends at reference numeral (1104).

FIG. 12 illustrates another method (1200) for operating the queue system in the invention. The method starts at reference numeral (1201).

At reference numeral (1202), the QMS receives a request from a user via a program on a computer or mobile individual end device (IED) having position location functionality for a desired service at a specific location. The message identifies the IED. The message can be sent in a wide variety of ways including by text, phone call, mobile app, website, etc.

At reference numeral (1203), the QMS notes the user's location, calculates the best route and returns to the IED a description of the best route and a suggested departure time or arrival when there are fewer customers for the business is offering better rates for service and sends a request to the user's device for user to join the queue when user's device is within a predetermined space.

At reference numeral 1204, the user is admitted to the physical queue upon arrival at the service location. The method ends at reference numeral (1105).

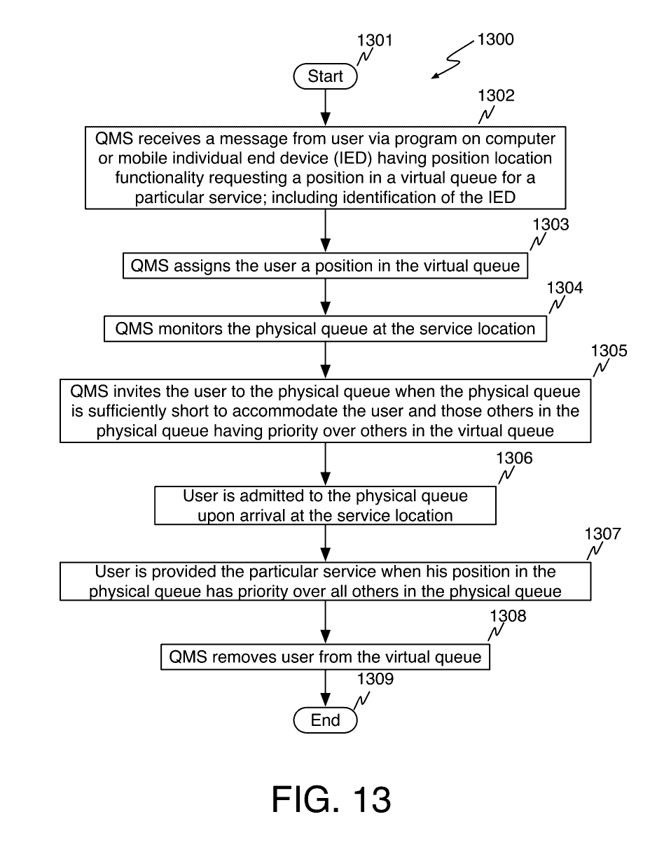

FIG. 13 illustrates one method (1300) for operating the queue system in the invention to provide the vendor of services or products with a system to limit the length of a physical queue at a service/product location for one of the provided services or products to within a predetermined maximum length. The method starts at reference numeral (1301).

In this aspect of the invention, at reference numeral (1302) the QMS receives a message from a user via a program on a computer or mobile individual end device (IED) having position location functionality requesting a position in a virtual queue for a particular service. The message identifies the IED. At reference numeral (1303) the queue managing system (102) assigns the user a position at the bottom of a virtual queue for the particular service.

At reference numeral (1304), the queue managing system (102) monitors the physical queue for the particular service at the service/product location.

At reference numeral (1305), the QMS sends a message to the IED (104) to invite the user to join the physical queue when the physical queue is sufficiently short to accommodate the user and those others in the physical queue having priority over others in the virtual queue. When the user nears the top of the virtual queue, such that the physical queue is sufficiently short to accommodate the user and those others already in the physical queue having priority over others in the virtual queue

At reference numeral (1306), the user is admitted to the physical queue. At reference numeral (1307) the user is provided the particular service when his or her position in the virtual queue has priority over all others in the physical queue.

After the user is provided the particular service or product, the QMS removes the user from the virtual queue at reference numeral (1308). The method ends at reference numeral (1309).

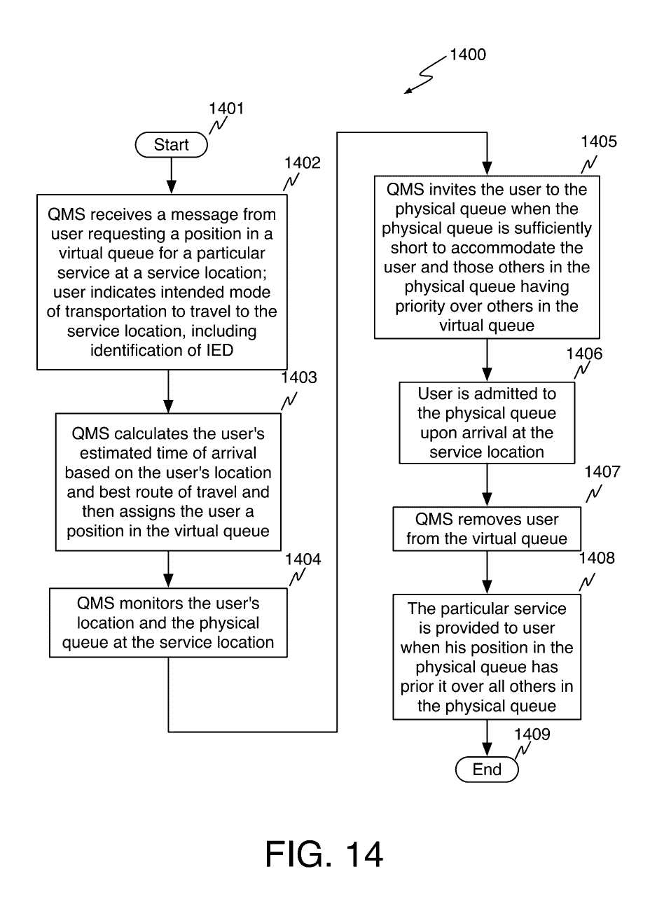

FIG. 14 illustrates another method (1400) for operation of the queue system in the invention to provide the vendor of services or products with a system to limit the length of a physical queue at a service/product location for one of the provided services or products to within a predetermined maximum length. This method employs GPS or similar position location functionality. The method begins at reference numeral (1401).

At reference numeral (1402), the QMS receives a message from a user requesting a position in a virtual queue for a particular service at a service location. The message from the user indicates an intended mode of transportation to travel to the service location. The message also identifies the individual-end device (104), either manually or automatically.

At reference numeral (1403), the QMS calculates the user's estimated time of arrival based on the user's location and best route of travel and then assigns the user a position in the virtual queue

At reference numeral (1404), the queue managing system (102) monitors the user's location and the physical queue at the service location.

At reference numeral (1405), the queue managing system (102) invites the user to the physical queue when the queue managing system (102) estimates that the user's ETA is a time when the physical queue will be sufficiently short to accommodate the user and those others in the physical queue having priority over others in the virtual queue.

Unless the user requests a later time, the user proceeds to the service location, whereupon the user is admitted to the physical queue at reference numeral (1406) when the physical queue is sufficiently short to accommodate the user and those others in the physical queue having priority over others in the virtual queue.

When the user is admitted to the physical queue, QMS removes the user from the virtual queue at reference numeral (1407).

At reference numeral (1408), the particular service is provided to the user when his or her position in the physical queue has priority over all others in the physical queue. The method ends at reference numeral (1409).

The above aspects of the invention can be applied to a wide variety of goods and services. The services can include public transportations services.

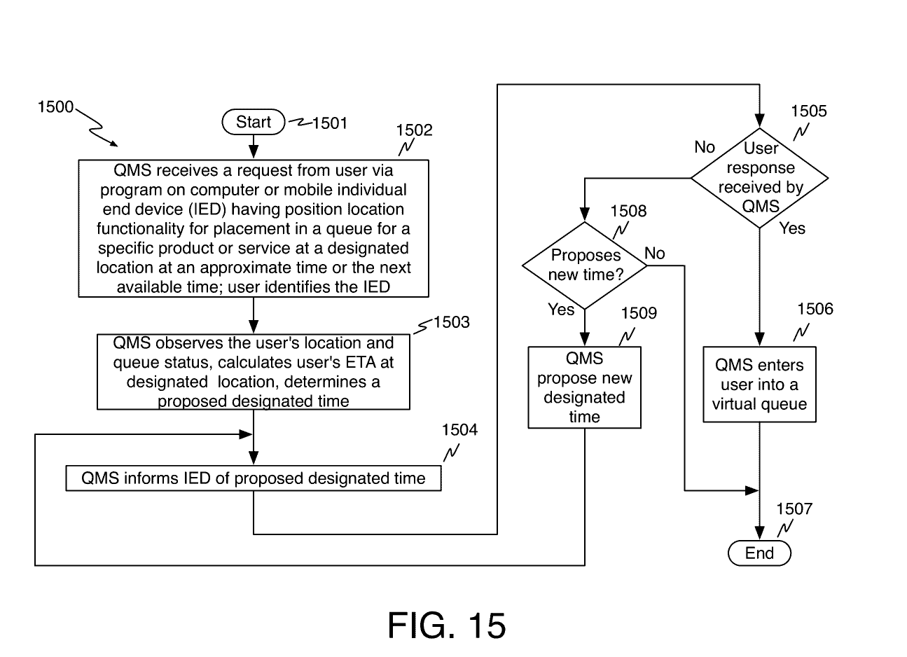

FIG. 15 illustrates another method (1500) for operation of the queue system in the invention to provide the vendor of services or products with a system to alter a user's position in the queue depending on the user's arrival time. This method employs GPS or similar position location functionality. The method begins at reference numeral (1501).

At reference numeral (1502), the QMS receives a request from user via program on computer or mobile individual end device (IED) having position location functionality for placement in a queue for a specific product or service at a designated location at an approximate time or the next available time. The message also identifies the individual-end device (104), either manually or automatically.

At reference numeral (1503), the QMS observes the user's location and queue status, calculates the user's ETA at the designated location, and determines a proposed designated time. At reference numeral (1504), the QMS informs the IED of the proposed designated time.

At reference numeral (1505), the QMS receives a response from the user. If the IED informs the QMS that the user accepts proposed designated time, the QMS enters the user into a virtual queue at reference numeral (1506). The method ends at reference numeral (1507).

If the IED informs the QMS that the user does not accept the proposed designated time, the QMS determines at reference numeral (1508) whether the user has proposed a new time. If the QMS determines that user has proposed a new time, the method returns to reference numeral (1504) where the QMS informs the IED of the proposed designated time. If the user has not proposed a new time, the method ends at reference numeral (1507).

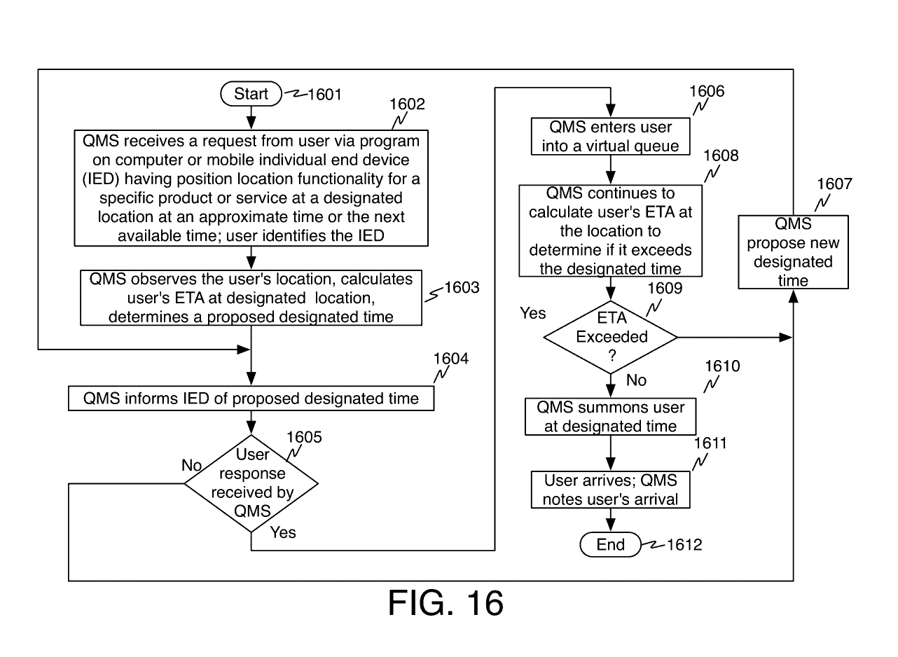

FIG. 16 illustrates another method (1600) for operation of the queue system in the invention to provide the vendor of services or products with a system to alter a user's position in the queue depending on the user's arrival time. This method employs GPS or similar position location functionality. The method begins at reference numeral (1601).

At reference numeral (1602), the QMS receives a request from a user via a program on computer or mobile individual end device (IED) having position location functionality for a specific product or service at a designated location at an approximate time or the next available time. The message also identifies the individual-end device (104), either manually or automatically.

At reference numeral (1603), the QMS observes the user's location, calculates the user's ETA at the designated location, and determines a proposed designated time. At reference numeral (1604), the QMS informs the IED of the proposed designated time.

At reference numeral (1605), the QMS receives a response from the user. If the IED informs the QMS that the user accepts proposed designated time, the QMS enters the user into a virtual queue at reference numeral (1606). If the IED informs the QMS that the user does not accept the proposed designated time, or if the user does not respond, the QMS proposes a new designated time at reference numeral (1607) and the method returns to reference numeral (1604) where the QMS informs the IED of the new proposed designated time.

If the response indicates that the user accepts the proposed designated time and the QMS enters the user into a virtual queue at reference numeral (1606), at reference numeral (1608), the QMS continues to calculate user's ETA at the location and at reference numeral (1609) it determines if the user's ETA exceeds the designated time. If not, at reference numeral (1610) the QMS summons the user at the designated time and at reference numeral (1611) the QMS notes the user's arrival. The method ends at reference numeral (1612).

If at reference numeral (1609), the QMS determines that the user's ETA exceeds the designated time, the method returns to reference numeral (1607) where the QMS suggests a new proposed designated time.

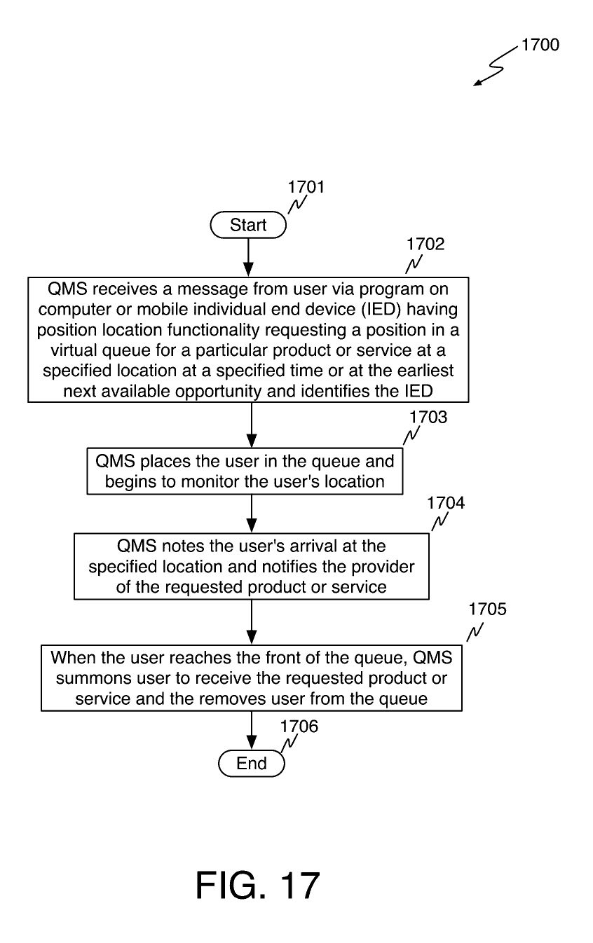

FIG. 17 illustrates another method (1700) for operation of the queue system in the invention to provide the vendor of services or products with a system to enter a user into a queue. This method employs GPS or similar position location functionality. The method begins at reference numeral (1701).

At reference numeral (1702), the QMS receives a message, from a user via a program on computer or mobile individual end device (IED) having position location functionality, requesting a position in a virtual queue for a particular product or service at a specified location at a specified time or at the earliest next available opportunity. The message identifies the IED.

At reference numeral (1703), the QMS places the user in the queue and begins to monitor the user's location.

At reference numeral (1704), the QMS notes the user's arrival at the specified location and notifies the provider of the requested product or service. At reference numeral (1705), when the user reaches the front of the queue, the QMS summons the user to receive the requested product or service and the user is removed from the queue. The method ends at reference numeral (1706).

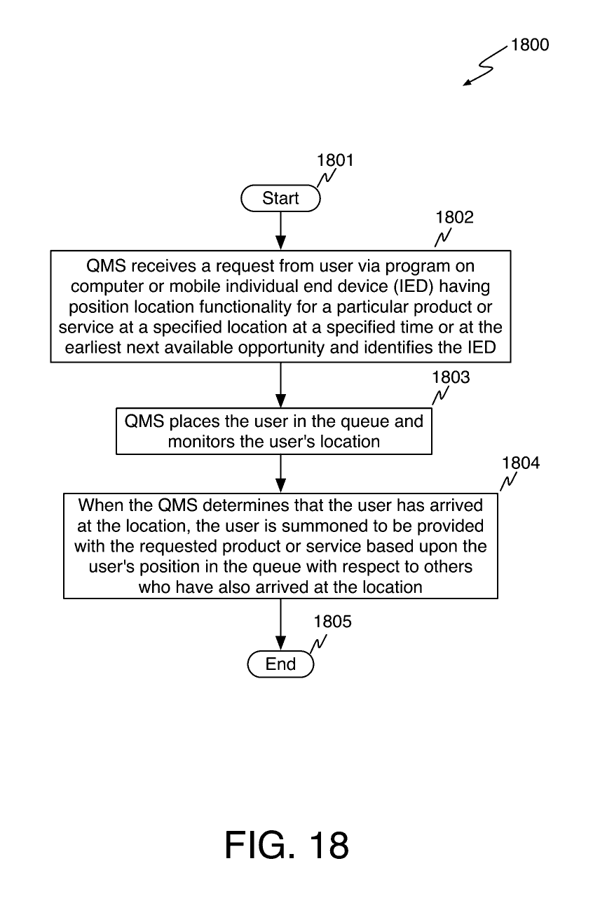

FIG. 18 illustrates another method (1800) for operation of the queue system in the invention to provide the vendor of services or products with a system to provide the products or services to users. This method employs GPS or similar position location functionality. The method begins at reference numeral (1801).

At reference numeral (1802), the QMS receives a request from a user via a program on computer or mobile individual end device (IED) having position location functionality for a particular product or service at a specified location at a specified time or at the earliest next available opportunity. The request also identifies the IED

At reference numeral (1803), the QMS places the user in the queue and monitors the user's location.

When the QMS determines that the user has arrived at the location, at reference numeral (1804), the QMS summons the user to be provided with the requested product or service based upon the user's position in the queue with respect to others who have also arrived at the location. The method ends at reference numeral (1805).

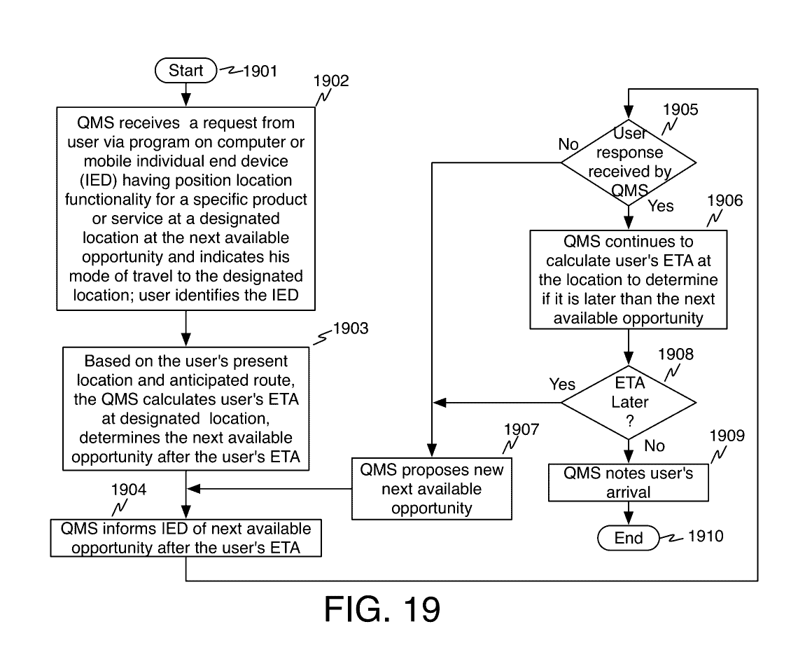

FIG. 19 illustrates another method (1900) for operation of the queue system in the invention to provide the vendor of services or products with a system to provide the products or services to users. This method employs GPS or similar position location functionality. The method begins at reference numeral (1901).

At reference numeral (1902), the QMS receives a request from a user via a program on computer or mobile individual end device (IED) having position location functionality for a specific product or service at a designated location at the next available opportunity and indicates his mode of travel to the designated location. The request also identifies the IED.

At reference numeral (1903), based on the user's present location and anticipated route, the QMS calculates the user's ETA at the designated location and determines the next available opportunity after the user's ETA.

At reference numeral (1904), the QMS informs the IED of the proposed next available opportunity. At reference numeral (1905), the user responds by accepting or rejecting the proposed next available opportunity. If the user accepts, the method proceeds to reference numeral (1906) where the QMS continues to calculate user's ETA at the location to determine if it is later than the next available opportunity. If the user rejects the next available opportunity, the QMS proposes a new next available opportunity at reference numeral (1907) and the method returns to reference numeral (1904).

If, at reference numeral (1908), the QMS never determines that the user's ETA is later than the selected next available opportunity, at reference numeral (1909) the QMS notes the users' arrival. The method ends at reference numeral (1910). If QMS determines at reference numeral (1908) that that the user's ETA is later than the selected next available opportunity, the QMS proposes a new next available opportunity at reference numeral (1907) and the method returns to reference numeral (1904).

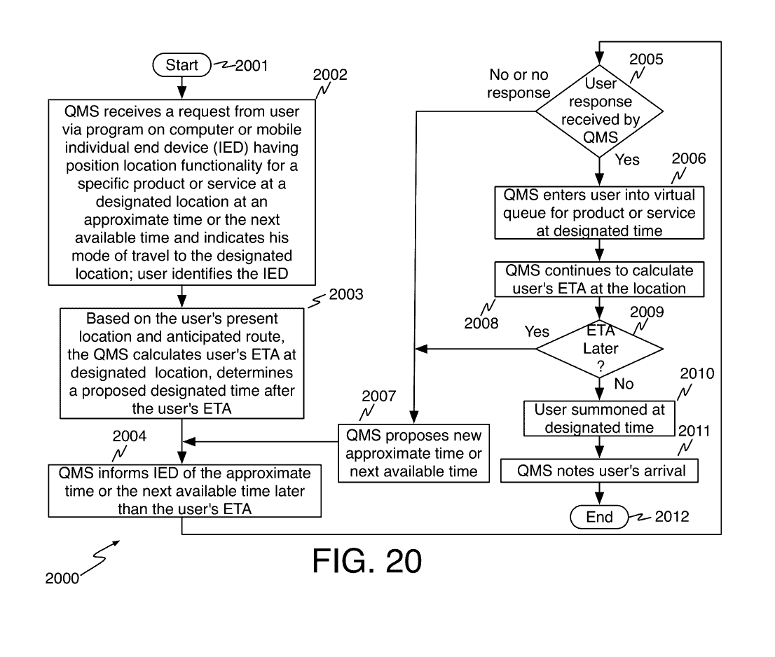

FIG. 20 illustrates another method (2000) for operation of the queue system in the invention to provide the provider of services or products with a system to provide the products or services to users. This method employs GPS or similar position location functionality. The method begins at reference numeral (2001).

At reference numeral (2002), the QMS receives a request from a user via a program on computer or mobile individual end device (IED) having position location functionality for a specific product or service at a designated location at an approximate time or the next available time and indicates his mode of travel to the designated location. The request identifies the IED.

At reference numeral (2003), based on the user's present location and anticipated route, the QMS calculates the user's ETA at designated location and determines a proposed designated time later than the user's ETA. At reference numeral (2004), the QMS informs the IED of the next available opportunity later than the user's ETA.

At reference numeral (2005), the QMS receives a response from the user. If the user accepts the proposed time, at reference numeral (2006) the QMS enters the user into the virtual queue for the product or service at the designated time. If the user rejects the proposed time, the method proceeds to reference numeral (2007) where the QMS proposes a new approximate time or next available time.

If the user has accepted the proposed time, at reference numeral (2008), the QMS continues to calculate the user's ETA at the designated location. At reference numeral (2009), the QMS determines whether the user's ETA will be later than the proposed time. If the user's ETA will never be later than the proposed time, the QMS summons the user at the designated time at reference numeral (2010). At reference numeral (2011) the user arrives at the designated location and the QMS notes the user's arrival. The method ends at reference numeral (2012).

If the user's ETA will be later than the proposed time, the method proceeds to reference numeral (2007), where the QMS again proposes a new approximate time or next available time.

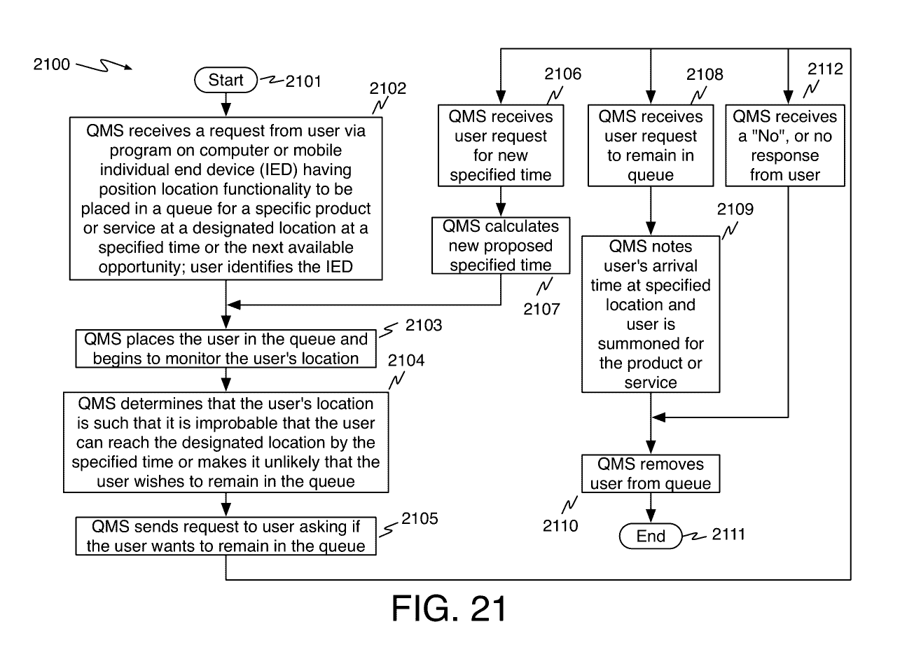

FIG. 21 illustrates a method (2100) for operation of the queue system in the invention to provide the vendor of services or products with a system to provide the products or services to users in situations where it appears that a user may not be able to arrive at an appointed time. This method employs GPS or similar position location functionality. The method begins at reference numeral (2101).

At reference numeral (2102), the QMS receives a request from a user via a program on computer or mobile individual end device (IED) having position location functionality to be placed in a queue for a specific product or service at a designated location at a specified time or the next available opportunity. The request identifies the IED.

At reference numeral (2103), the QMS places the user in the queue and begins to monitor the user's location. At reference numeral (2104), the QMS determines that the user's location is such that it is improbable that the user can reach the designated location by the specified time or makes it unlikely that the user wishes to remain in the queue. At reference numeral (2105), the QMS sends a request to user asking if the user wants to remain in the queue.

The user may respond to this request in several different ways. If, at reference numeral (2107), the QMS receives a user request for a new specified time to receive the products or services, the method proceeds to reference numeral (2107) where the QMS calculates a new proposed specified time based on the user's location and returns to reference numeral (2103) where the QMS places the user in the queue in accordance with the new information. If, at reference numeral (2108), the QMS received a message that user requests to remain in the queue, the method proceeds to reference numeral (2109) where the QMS notes the user's arrival time at specified location and user is summoned for the product or service. Next, at reference numeral (2110), the user is removed from the queue. The method ends at reference numeral (2111). If, at reference numeral (2108), the QMS has received a response that user does not wish to remain in the queue or the user has not responded, the method proceeds to reference numeral 2110 where the user is removed from the queue.

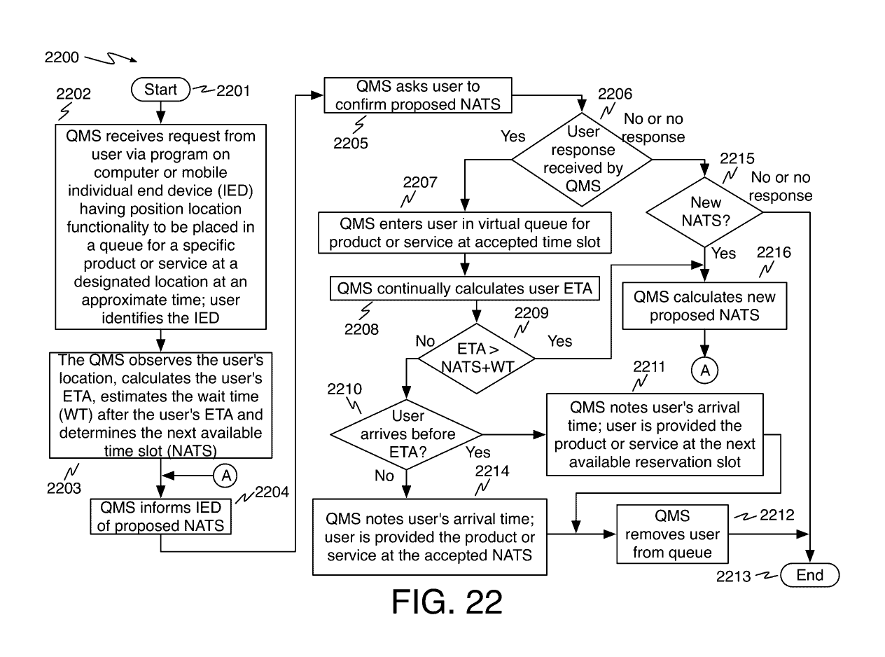

FIG. 22 illustrates a method (2200) for operation of the queue system in the invention to provide the vendor of services or products with a system to provide the products or services to users in situations where the services are provided in time slots and it appears that a user may not be able to arrive at an appointed time. This method employs GPS or similar position location functionality. The method begins at reference numeral (2201).

At reference numeral (2202), the QMS receives request from a user via a program on computer or mobile individual end device (IED) having position location functionality to be placed in a queue for a specific product or service at a designated location at an approximate time. The request identifies the IED.

At reference numeral (2203), the QMS observes the user's location, calculates the user's ETA, estimates the wait time (WT) after the user's ETA and determines the next available time slot (NATS). At reference numeral (2204), the QMS informs the IED of the proposed NATS and at reference numeral (2205) the QMS asks the user to confirm the proposed NATS.

At reference numeral (2206), the QMS receives a response from the user. If the user has confirmed the proposed NATS, the QMS enters the user in virtual queue for the product or service at the accepted time slot at reference numeral (2207). The QMS then continually calculates the user's ETA based on the user's current position at reference numeral (2208). If the user's ETA never exceeds the NATS plus the wait time WT as determined at reference numeral (2209), the QMS determines at reference numeral (2210) if the user has arrived before or after the ETA. If the user has arrived before the ETA, at reference numeral (2211), QMS notes the user's arrival time and the user is provided the product or service at the next available reservation slot. Then, at reference numeral (2212), the QMS removes the user from the queue and the method ends at reference numeral (2213).

If the user does not arrive before the ETA, at reference numeral (2214), the QMS notes the user's arrival time and the user is provided the product or service at the accepted NATS. Then, at reference numeral (2212) the QMS removes the user from the queue and the method ends at reference numeral (2213).

If the response received by the QMS by the user at reference numeral (2206) is a refusal to confirm the NATS, or if the user has failed to respond, at reference numeral (2215) the QMS inquires whether the user would like a new NATS. If the user declines or does not respond, the method ends at reference numeral (2213). If the user has responded that a new NATS is desired, the method proceeds to reference numeral (2216) where the QMS calculates a new proposed NATS. The method then proceeds to reference numeral (2204) where the QMS informs the IED of the proposed NATS.

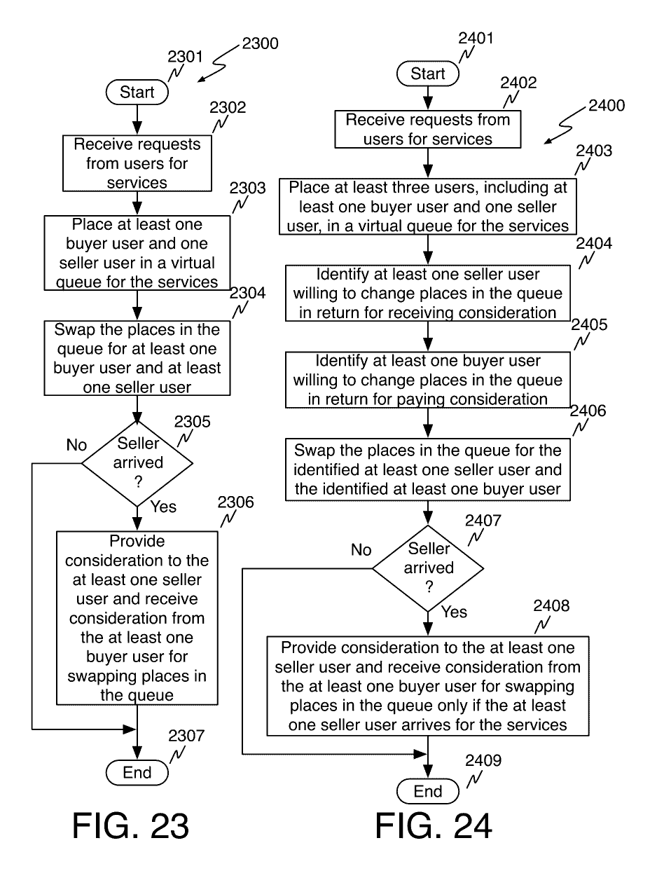

FIG. 23 is a flow diagram illustrating a scenario in the use of a method (2300) for swapping places in a queue in accordance with the present invention. The method begins at reference numeral (2301).

At reference numeral (2302), the QMS receives requests from users for services. At reference numeral (2303), the QMS places at least one buyer user and one seller user in a virtual queue for the services. At reference numeral (2304), the QMS swaps the places in the queue for at least one buyer user and at least one seller user. At reference numeral (3205), the QMS determines if the seller has arrived for the services. If the seller has arrived for the services, the method proceeds to reference numeral (2306) where the QMS provides consideration to the at least one seller user and receives consideration from the at least one buyer user for swapping places in the queue. The method ends at reference numeral (2307). If the seller has not arrived for the services, the swap is canceled and the method ends at reference numeral (2307).

FIG. 24 is a flow diagram illustrating another scenario in the use of a method (2400) for swapping places in a queue in accordance with the present invention. The method begins at reference numeral (2401).

At reference numeral (2402), the QMS receives requests from users for services. At reference numeral (2403), the QMS places at least three users, including at least one buyer user and one seller user in a virtual queue for the services. At reference numeral (2404), the QMS identifies at least one seller user willing to change places in the queue in return for receiving consideration. At reference numeral (2405), the QMS identifies at least one buyer user willing to change places in the queue in return for paying consideration. At reference numeral (2406), the QMS swaps the places in the queue for the identified at least one buyer user and the identified at least one seller user. At reference numeral (2407), the QMS determines if the at least one seller has arrived for the services. If the at least one seller has arrived for the services, the method proceeds to reference numeral (2408) where the QMS provides consideration to the at least one seller user and receives consideration from the at least one buyer user for swapping places in the queue. The method ends at reference numeral (2409). If the seller has not arrived for the services, the swap is canceled and the method ends at reference numeral (2409).

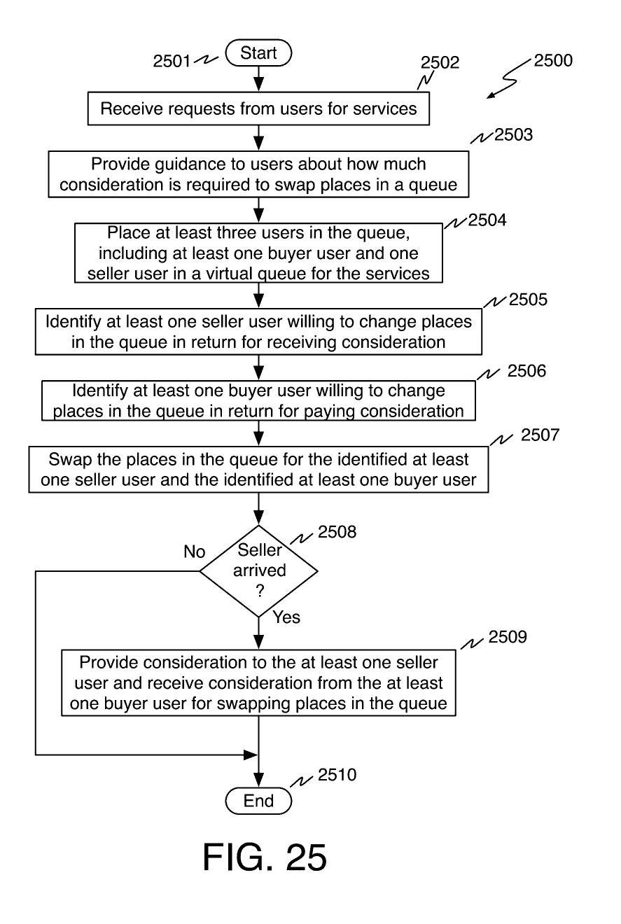

FIG. 25 is a flow diagram illustrating another scenario in the use of a method (2500) for swapping places in a queue in accordance with the present invention. The method begins at reference numeral (2501).

At reference numeral (2502), the QMS receives requests from users for services. At reference numeral (2503), the QMS provides guidance to users about how much consideration is required to swap places in a queue. At reference numeral (2504), the QMS places at least three users, including at least one buyer user and one seller user in a virtual queue for the services. At reference numeral (2505), the QMS identifies at least one seller user willing to change places in the queue in return for receiving consideration. At reference numeral (2506), the QMS identifies at least one buyer user willing to change places in the queue in return for paying consideration. At reference numeral (2507), the QMS swaps the places in the queue for the identified at least one buyer user and the identified at least one seller user. At reference numeral (2508), the QMS determines if the at least one seller has arrived for the services. If the at least one seller has arrived for the services, the method proceeds to reference numeral (2509) where the QMS provides consideration to the at least one seller user and receives consideration from the at least one buyer user for swapping places in the queue. The method ends at reference numeral (2510). If the seller has not arrived for the services, the swap is canceled and the method ends at reference numeral (2510).

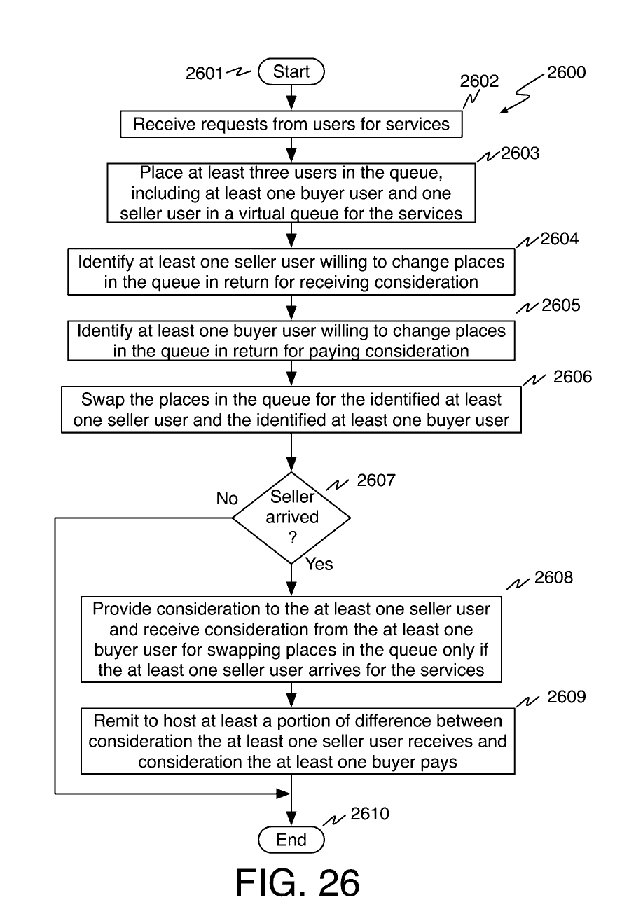

FIG. 26 is a flow diagram illustrating another scenario in the use of a method (2600) for swapping places in a queue in accordance with the present invention. The method begins at reference numeral (2601).

At reference numeral (2602), the QMS receives requests from users for services. At reference numeral (2603), the QMS places at least three users, including at least one buyer user and one seller user in a virtual queue for the services. At reference numeral (2604), the QMS identifies at least one seller user willing to change places in the queue in return for receiving consideration. At reference numeral (2605), the QMS identifies at least one buyer user willing to change places in the queue in return for paying consideration. At reference numeral (2506), the QMS swaps the places in the queue for the identified at least one buyer user and the identified at least one seller user. At reference numeral (2607), the QMS determines if the at least one seller has arrived for the services. If the at least one seller has arrived for the services, the method proceeds to reference numeral (2608) where the QMS provides consideration to the at least one seller user and receives consideration from the at least one buyer user for swapping places in the queue. At reference numeral (2609), the QMS remits to host at least a portion of difference between consideration the at least one seller user receives and consideration the at least one buyer pays. The method ends at reference numeral (2610). If the seller has not arrived for the services, the swap is canceled and the method ends at reference numeral (2610).

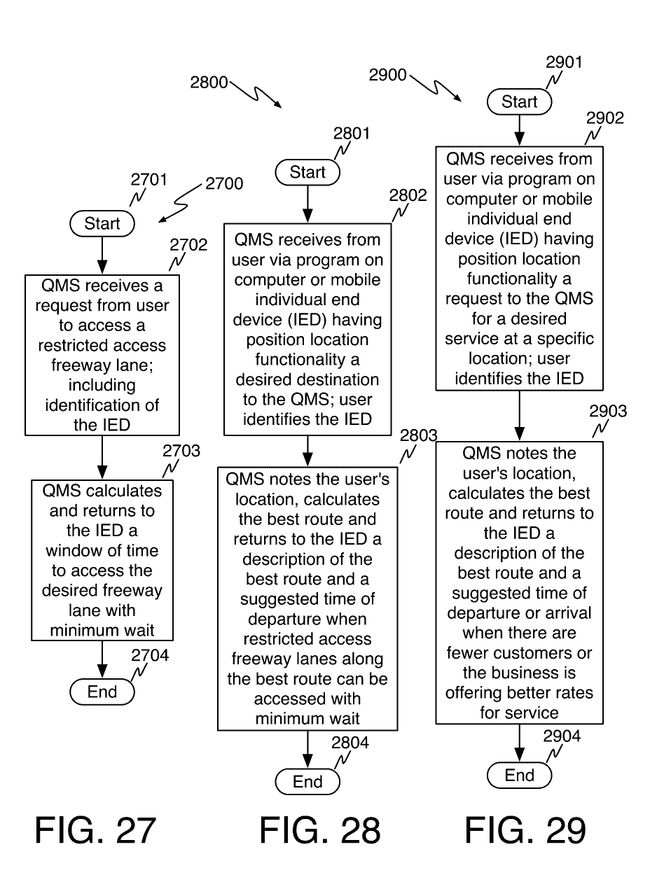

FIG. 27 is a flow diagram illustrating a scenario in the use of a method (2700) for providing access to a highway in accordance with the present invention. The method begins at reference numeral (2701).

At reference numeral (2702), the QMS receives a request from a user to access a restricted access freeway lane. The request includes identification of the IED. At reference numeral (2703), the QMS calculates and returns to the IED a window of time to access the desired freeway lane with minimum wait time. The method ends at reference numeral (2704).

FIG. 28 is a flow diagram illustrating another scenario in the use of a method (2800) for proceeding to a desired destination in accordance with the present invention. The method begins at reference numeral (2801).

At reference numeral (2802), the QMS receives from a user via a program on a computer or a mobile individual end device (IED) having position location functionality a desired destination to the QMS. The message from the user includes identification of the IED. At reference numeral (2803), the QMS notes the user's location, calculates the best route and returns to the IED a description of the best route and a suggested time of departure when restricted access freeway lanes along the best route can be accessed with minimum wait time. The method ends at reference numeral (2804).

FIG. 29 is a flow diagram illustrating another scenario in the use of a method (2900) for obtaining service at a desired destination in accordance with the present invention. The method begins at reference numeral (2901).

At reference numeral (2902), the QMS receives from a user via a program on a computer or a mobile individual end device (IED) having position location functionality a request to the QMS for a desired service at a specific location. The request includes identification of the IED. At reference numeral (2904), the QMS notes the user's location, calculates the best route and returns to the IED a description of the best route and a suggested time of departure or arrival when there are fewer customers or the business is offering better rates for service. The method ends at reference numeral (2904).

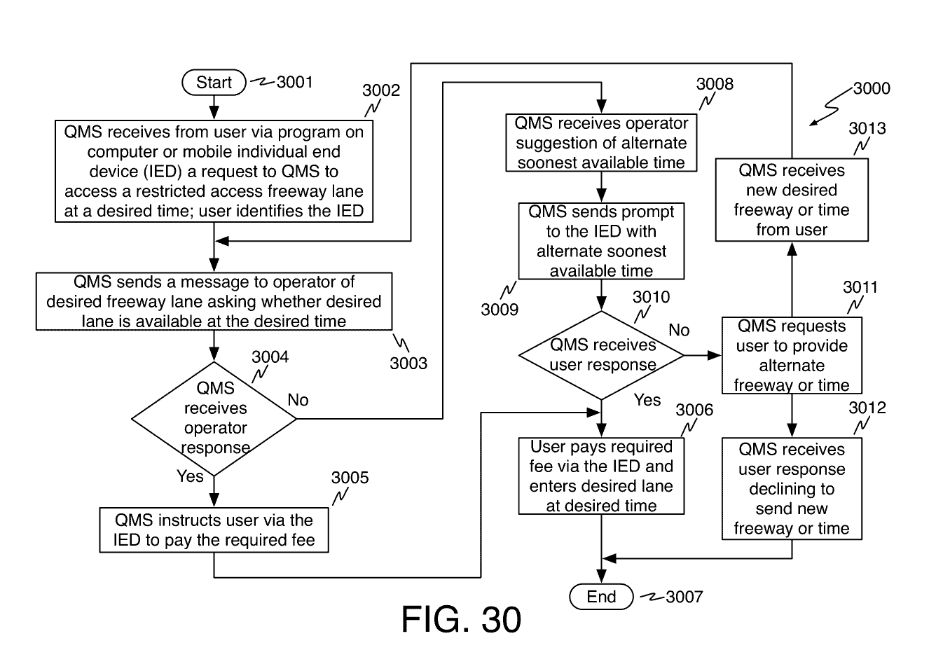

FIG. 30 is a flow diagram illustrating another scenario in the use of method (3000) for providing access to a highway in accordance with the present invention. The method begins at reference numeral (3001).

At reference numeral (3002), the QMS receives from a user via a program on a computer or a mobile individual end device (IED) a request to the QMS to access a restricted access freeway lane at a desired time. The request includes an identification of the IED. At reference numeral (3003), the QMS sends a message to the operator of the desired freeway lane asking whether the desired lane is available at the desired time. At reference numeral (3004), the QMS receives a reply from the operator. If the response is that the lane is available at the requested time at reference numeral (3005) the QMS instructs the user via the IED to pay the required fee. At reference numeral (3006), the user pays the required fee and enters the desired lane at the desired time. The method ends at reference numeral (3007).

If the response is that the lane is not available at the requested time at reference numeral (3008), the QMS receives a suggestion from the operator of an alternate soonest available time. At reference numeral (3009), the QMS sends a prompt to the IED with the alternate soonest available time. At reference numeral (3010), the QMS receives a response from the IED. If the response was an acceptance of the suggestion, the method proceeds to reference numeral (3006) where the user pays the required fee and enters the desired lane at the desired time. The method then ends at reference numeral (3007).

If the response at reference numeral (3010) was a rejection of the suggestion, the method proceeds to reference numeral (3011) where the QMS requests the user to provide alternate freeway or time choice. At reference numeral (3013), the QMS receives a new desired freeway or time choice and the method proceeds to reference numeral (3003) where the QMS sends a message to the operator of the desired freeway lane asking whether the desired lane is available at the desired time. If the QMS instead receives, at reference numeral (3012), a user response declining to send a new freeway or time, the method ends at reference numeral (3007).

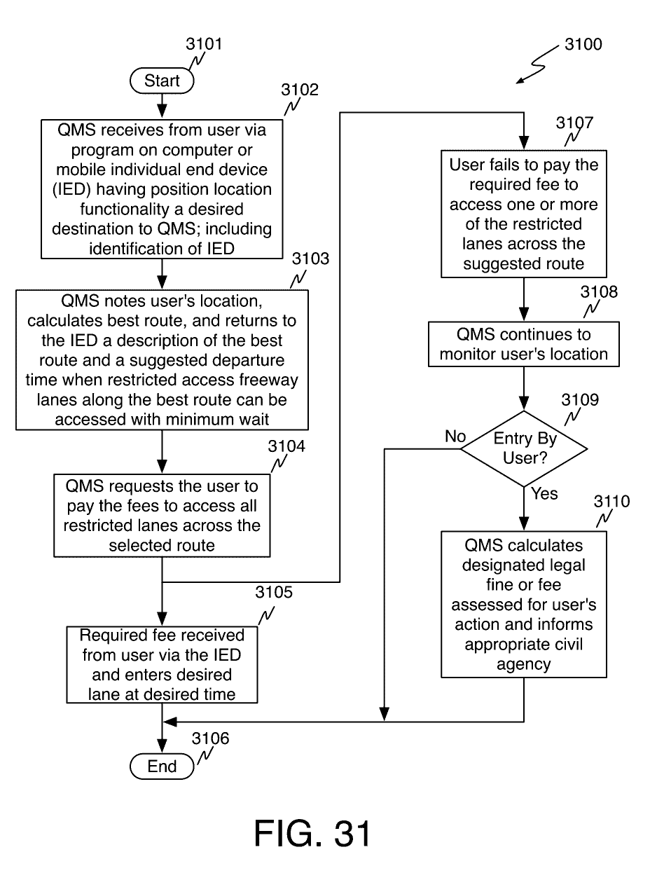

FIG. 31 is a flow diagram illustrating another scenario in the use of a method (3100) for providing access to a highway in accordance with the present invention. The method begins at reference numeral (3101).

At reference numeral (3102), the QMS receives from a user via a program on a computer or a mobile individual end device (IED) having position location functionality a desired destination to QMS. The message from the IED includes identification of the IED. At reference numeral (3103), the QMS notes user's location, calculates the best route, and returns to the IED a description of the best route and a suggested departure time when restricted access freeway lanes along the best route can be accessed with minimum wait.

At reference numeral (3104), the QMS requests the user to pay the fees to access all restricted lanes across the selected route. At reference numeral (3105), the required fee is received from user via the IED and the user enters the desired lane at the desired time. If, instead however, at reference numeral (3107), the user fails to pay the required fee to access one or more of the restricted lanes across the suggested route, at reference numeral (3108) the QMS continues to monitor the user's location.

If, at reference numeral (3109), entry by user onto one of the restricted access lanes along the suggested route for which payment has not been made is not sensed, then the method ends at reference numeral (3106). If, at reference numeral (3109), entry by user onto one of the restricted access lanes along the suggested route for which payment has not been made is sensed, then at reference numeral (3110) the QMS calculates a designated legal fine or fee assessed for user's action and informs the appropriate civil agency and the method ends at reference numeral (3106).

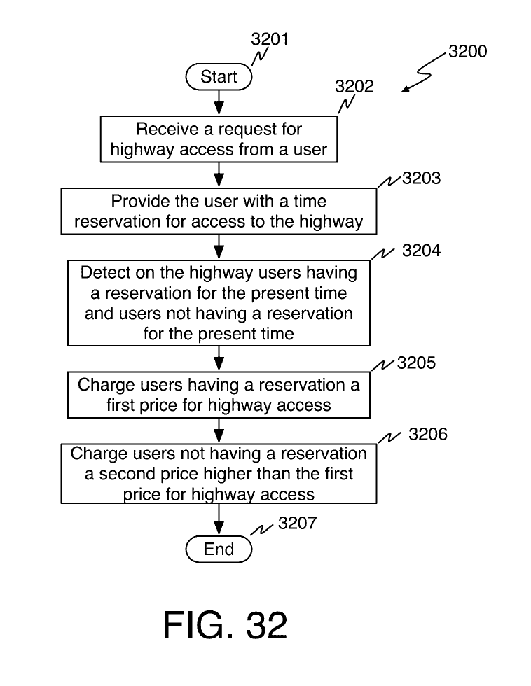

FIG. 32 is a flow diagram illustrating another scenario in the use of a method (3200) for providing access to a highway in accordance with the present invention. The method begins at reference numeral (3201).

At reference numeral (3202), the QMS receives a request for highway access from a user via a program on a computer or a mobile individual end device (IED) having position location functionality a desired destination to QMS. The message from the IED includes identification of the IED. At reference numeral (3103), the QMS provides the user with a time reservation for access to the highway. At reference numeral (3104), users on the highway having a reservation for the present time and users on the highway not having a reservation for the present time are detected. At reference numeral (3205), users having a reservation are charged a first price for highway access. At reference numeral (3106), users not having a reservation are charged a second price higher than the first price for highway access. The method ends at reference numeral (3207).

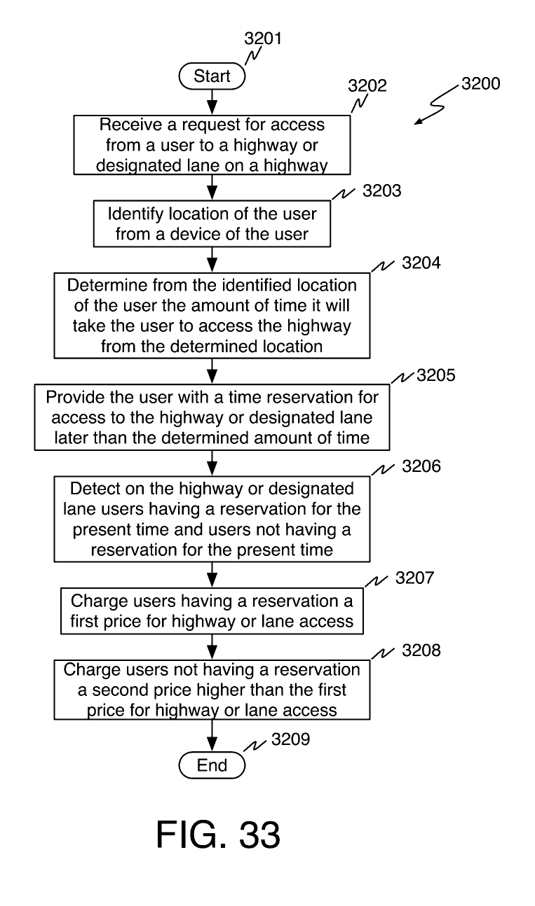

FIG. 33 is a flow diagram illustrating another scenario in the use of a method (3300) for providing access to a highway in accordance with the present invention. The method begins at reference numeral (3301).

At reference numeral (3302), the QMS receives a request for access from a user via a program on a computer or a mobile individual end device (IED) having position location functionality to a highway or designated lane on a highway. At reference numeral (3303), the QMS identifies the location of the user from the IED device of the user. At reference numeral (3304) from the identified location of the user, the QMS determines the amount of time it will take the user to access the highway from the determined location. At reference numeral (3305), the QMS provides the user with a time reservation for access to the highway or designated lane later than the determined amount of time. At reference numeral (3306), users having a reservation for the present time and users not having a reservation for the present time are detected on the highway or designated lane. At reference numeral (3307), users having a reservation are charged a first price for highway or lane access and at reference numeral (3308) users not having a reservation are charged a second price higher than the first price for highway or lane access. The method ends at reference numeral (3309).

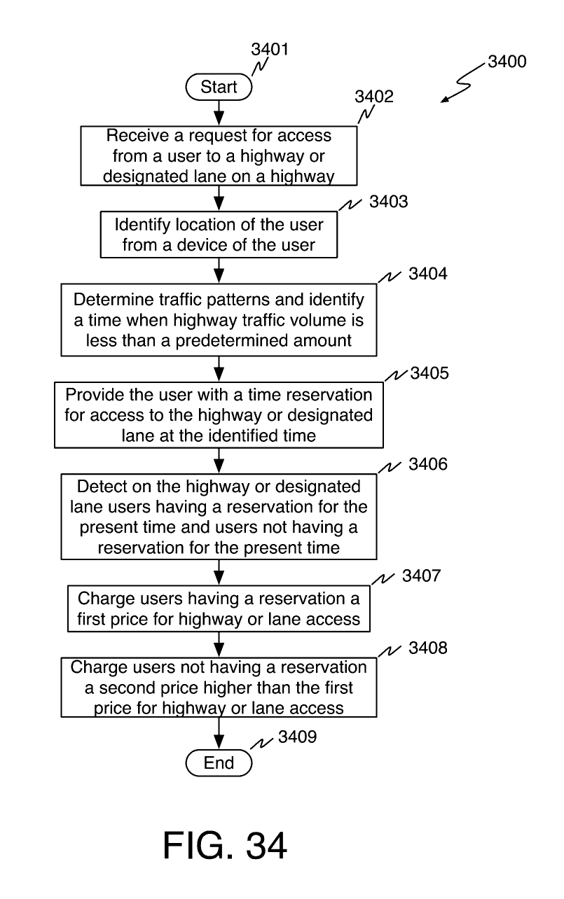

FIG. 34 is a flow diagram illustrating another scenario in the use of a method (3400) for providing access to a highway in accordance with the present invention. The method begins at reference numeral (3401).

At reference numeral (3402), the QMS receives a request for access from a user via a program on a computer or a mobile individual end device (IED) having position location functionality to a highway or designated lane on a highway. At reference numeral (3403), the QMS identifies the location of the user from the IED device of the user. At reference numeral (3304) from the identified location of the user, the QMS determines traffic patterns and identifies a time when highway traffic volume is less than a predetermined amount. The threshold of the predicted amount may be determined emperically.

At reference numeral (3405), the QMS provides the user with a time reservation for access to the highway or designated lane at the identified time. At reference numeral (3406), the QMS detects, from sensors on the highway or from the users' IED devices, users on the highway or designated lane having a reservation for the present time and users not having a reservation for the present time. At reference numeral (3407), users having a reservation are charged a first price for highway or lane access and at reference numeral (3408) users not having a reservation are charged a second price higher than the first price for highway or lane access. The method ends at reference numeral (3409).

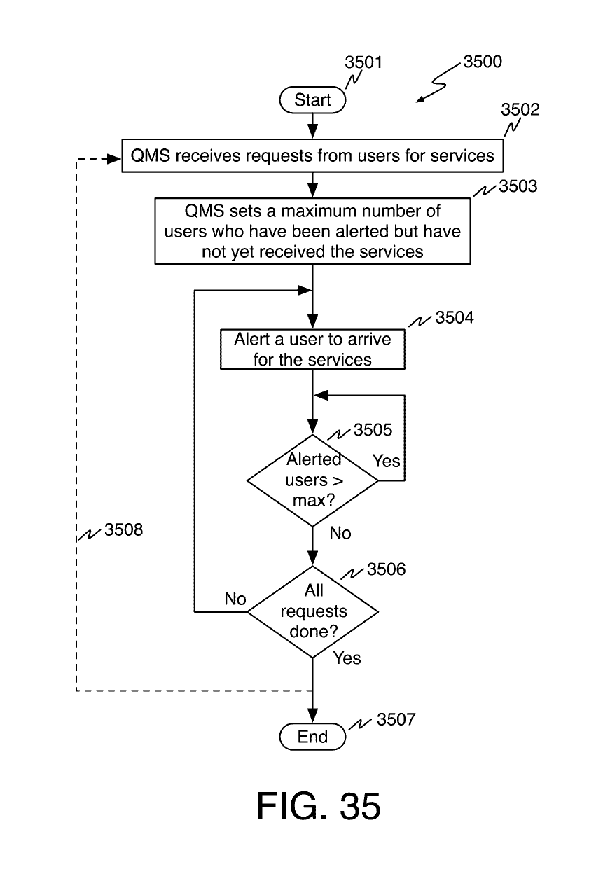

FIG. 35 is a flow diagram illustrating another scenario in the use of a method (3500) for managing a queue for providing services in accordance with the present invention. The method begins at reference numeral (3501).

At reference numeral (3502), the QMS receives requests for services from users via a program on a computer or a mobile individual end device (IED) associated with each user. At reference numeral (3503), the QMS sets a maximum number of users who have been alerted but have not yet received the services. This maximum number will vary from establishment to establishment and will depend on factor individual to each location.

At reference numeral (3504), the QMS alerts a user to arrive for the services. At reference numeral (3505), the QMS determines whether the number of users who have been alerted but have not yet received the services is at the maximum. If so, the method loops back to reference numeral (3505) until the number of users who have been alerted but have not yet received the services is below the maximum. If the number of users who have been alerted but have not yet received the services is not at the maximum, the method proceeds to reference numeral 3506, where the QMS determines whether all requests have been processed. If so, the method ends at reference numeral (3507) or can loop back to reference numeral (3502) as shown by the dashed line (3508). If all requests have not been processed, the method returns to reference numeral (3504) and the QMS alerts another user to arrive for the services.

It is to be understood that the foregoing disclosure is not limited to any particular method or system. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the invention as described.

What is claimed is:

1. A computer implemented method for controlling a queue for services comprising the steps of:
a) providing a user with a software application for use with a device that can send the device's location;
b) receiving at the server the location of the user's device;
c) maintaining a virtual queue with the server; and
d) sending a request to the user's device for the user to join the queue when the user's device is within a predetermined space.

2. The method of claim 1, further comprising, after step (d), receiving a request from the user to join the virtual queue and placing the user in the virtual queue.

3. The method of claim 2, wherein the predetermined space is a store and an associated parking lot.

4. The method of claim 1, further comprising receiving a request from the user to be removed from the queue or change place in the queue, and changing the virtual queue in accordance with the user's request.

5. A computer implemented method for controlling reservations for services comprising the steps of:
a) receiving a request from a user for services;
b) determining the location of the user directly from a device of the user that provides location information;
c) determining a first amount of time it will take the user to arrive for the services from the determined location;
d) placing the user in a queue with a first reservation time, the first reservation time being no earlier than the time it is determined that the user will arrive; and
e) communicating to the user the first reservation time.

6. The method of claim 5, further comprising receiving from the user a second reservation time later than the first reservation time and then placing the user in the queue with the second reservation time.

7. The method of claim 5, further comprising:
f) advising the user when to leave the user's determined location to obtain the services.

8. The method of claim 5, further comprising:
f) determining a second amount of time it will take the user to arrive for the services from the determined location at a second service location; and
g) advising the user of at least the shorter of the first and second amounts of time.

9. The method of claim 8, wherein the step of advising comprises advising the user of both the first and second amounts of time.

10. The method of claim 9, wherein the step of advising comprises providing the amounts of time from the shortest to the longest.

11. The method of claim 5, further comprising:
f) determining that the user is within a predetermined distance from the service provider;
g) after step (f) determining that the user is no longer within the predetermined distance; and
h) after step (g) querying the user if the user wants to receive the services.

12. A computer implemented method for controlling a virtual queue for services comprising the steps of:
a) receiving a request from users for the services;
b) placing the users in a virtual queue for the services, the users including at least one buyer user and at least one seller user;
c) swapping the places in the virtual queue of the at least one buyer user and the at least one seller user; and
d) providing consideration to the at least one seller user for swapping the places in the virtual queue only if the at least one seller arrives for the services.

13. The method of claim 12, wherein the at least one buyer user is farther back in the virtual queue than is the at least one seller user.

14. The method of claim 12, further comprising auctioning the at least one seller's place in the virtual queue.

15. The method of claim 12, wherein:
the at least one buyer user and the at least one seller user comprise a plurality of seller users and a plurality of buyer users,
consideration is provided by each seller user and consideration is requested by each buyer user, and
further comprising matching the plurality of buyer users and the plurality of selling users to maximize a difference between what buyer users provide in consideration and seller users are to receive in consideration, wherein the difference is received by a host.

16. The method of claim 15, further comprising remitting to the host at least a portion of the difference.

17. The method of claim 16, further comprising providing guidance to the users about how much consideration is required to swap places in the virtual queue.

18. A method for managing a virtual queue adapted to correspond to an actual queue, comprising:
establishing a virtual queue on an electronic queue-managing system, the virtual queue adapted to correspond to an actual queue;
establishing a bi-directional communication means with an individual who wants to enter, has entered, or has left the virtual queue;
establishing a bi-directional electronic communication between the electronic queue-managing system and an entity that manages or provides the actual queue according to status of the virtual queue;
updating the virtual queue according to information received from the individual and information from the entity, wherein the individual requests a first available position in the virtual queue using the bi-directional communication means;
summoning the individual to the actual queue once the position of the individual in the virtual queue reaches the front of the virtual queue; and
swapping a position in the virtual queue with another position in the virtual queue.

19. The method of claim 18, wherein swapping a position is between a first user and a second user.

20. The method of claim 19, wherein swapping a position is based on a compensation between the first user and the second user.
